(19) United States
(12) Patent Application Publication
(10) Pub. No.: US 2024/0235811 A1
(43) Pub. Date: Jul. 11, 2024

(54) AUTHENTICATED ENCRYPTION APPARATUS, AUTHENTICATED DECRYPTION APPARATUS, AUTHENTICATED ENCRYPTION SYSTEM, METHOD, AND COMPUTER READABLE MEDIUM

(71) Applicant: NEC Corporation, Minato-ku, Tokyo (JP)

(72) Inventor: Akiko Mukai, Tokyo (JP)

(73) Assignee: NEC Corporation, Minato-ku, Tokyo (JP)

(21) Appl. No.: 18/558,417

(22) PCT Filed: May 12, 2021
(86) PCT No.: PCT/JP2021/018124

§ 371 Date: Nov. 1, 2023

(51) Int. Cl. H04L 9/06; G06F 7/58; H04L 9/32

(52) U.S. Cl. CPC H04L 9/0618; G06F 7/588; H04L 9/3242

(57) ABSTRACT

Encryption means encrypts a plaintext on an area-by-area basis by using a Tweakable block cipher using a nonce as a Tweak, the plaintext being divided into plaintext blocks each having a predetermined length, and each area having a predetermined length. Random number calculation means generates a set of random numbers for each area by using first data and a predetermined matrix having predetermined values as elements, the first data being derived, in the encryption, from at least one of an input and an output of a function related to the Tweakable block cipher in each area. Tag generation means generates, by using the set of random numbers and the nonce, an authentication tag by a message authentication code using the Tweakable block cipher.

### TECHNICAL FIELD

The present invention relates to an authenticated encryption apparatus, an authenticated decryption apparatus, an authenticated encryption system, a method, and a computer readable medium.

### BACKGROUND ART

Authenticated encryption (AE; Authenticated Encryption) in which encryption and authentication-tag calculation for detecting tampering are simultaneously performed on a plaintext message by using a private key that is shared in advance has been known. By applying the authenticated encryption AE to a communication channel, it is possible to conceal information and the like against eavesdropping and detect unauthorized tampering made thereto, and as a result, strong protection for communicated information and the like is realized. As an authenticated encryption technology, for example, a technology disclosed in Non-patent Literature 1 has been known. In the case where primitives (cryptoparts) having a b-bit input/output (i.e., the length of a plaintext block is b bits) are used, the security is typically b bits at the maximum. However, according to the algorithm PFBω disclosed in Non-patent Literature 1, it is possible to achieve security (security level) of ωb bits higher than b bits.

### CITATION LIST

### Non Patent Literature

Non-patent Literature 1: Yusuke Naito, Yu Sasaki, and Takeshi Sugawara, “Lightweight Authenticated Encryption Mode Suitable for Threshold Implementation”, IACR Cryptology ePrint Archive: Report 2020/542, https://eprint.iacr.org/2020/542.pdf

### SUMMARY OF INVENTION

### Technical Problem

In the technology disclosed in Non-patent Literature 1, there is a limit on the number of plaintext blocks that can be processed in one authenticated encryption process due to security reasons. Therefore, in the technology disclosed in Non-patent Literature 1, although the security can be improved, it is difficult to encrypt a long plaintext all at once due to the limitation on the number of plaintext blocks that can be processed in one authenticated encryption process.

The present disclosure has been made to solve the above-described problem, and an object thereof is to provide an authenticated encryption apparatus, an authenticated decryption apparatus, and an authenticated encryption system, a method, and a computer readable medium capable of both increasing the number of plaintext blocks that can be processed in one authenticated encryption process and achieving high security.

### Solution to Problem

An authenticated encryption apparatus according to the present disclosure includes: encryption means for encrypting a plaintext on an area-by-area basis by using a Tweakable block cipher using a nonce as a Tweak, the plaintext being divided into plaintext blocks each having a predetermined length, and each area having a predetermined length; random number calculation means for generating a set of random numbers for each area by using first data and a predetermined matrix having predetermined values as its elements, the first data being derived, in the encryption, from at least one of an input and an output of a function related to the Tweakable block cipher in each area; and tag generation means for generating, by using the set of random numbers and the nonce, an authentication tag by a message authentication code using the Tweakable block cipher.

Further, an authenticated decryption apparatus according to the present disclosure includes: decryption means for decrypting a ciphertext on an area-by-area basis by using a Tweakable block cipher using a nonce as a Tweak, the ciphertext being divided into ciphertext blocks each having a predetermined length, and each area having a predetermined length; random number calculation means for generating a set of random numbers for each area by using first data and a predetermined matrix having predetermined values as its elements, the first data being derived, in the decryption, from at least one of an input and an output of a function related to the Tweakable block cipher in each area; tag generation means for generating, by using the set of random numbers and the nonce, a verification tag by a message authentication code using the Tweakable block cipher; and tag verification means for verifying whether tempering has occurred or not by comparing the verification tag with an input authentication tag, and performing control for outputting a verification result.

Further, an authenticated encryption system according to the present disclosure includes: an authenticated encryption apparatus; and an authenticated decryption apparatus configured to communicate with the authenticated encryption apparatus, in which the authenticated encryption apparatus includes: encryption means for encrypting a plaintext on an area-by-area basis by using a Tweakable block cipher using a nonce as a Tweak, the plaintext being divided into plaintext blocks each having a predetermined length, and each area having a predetermined length; first random number calculation means for generating a set of random numbers for each area by using data and a predetermined matrix having predetermined values as its elements, the data being derived, in the encryption, from at least one of an input and an output of a function related to the Tweakable block cipher in each area; and first tag generation means for generating, by using the set of random numbers and the nonce, an authentication tag by a message authentication code using the Tweakable block cipher, and the authenticated decryption apparatus includes: decryption means for decrypting a ciphertext on an area-by-area basis by using the Tweakable block cipher using the nonce as the Tweak, the ciphertext being divided into ciphertext blocks each having a predetermined length, and each area having a predetermined length; second random number calculation means for generating a set of random numbers for each area by using data and a predetermined matrix having predetermined values as its elements, the data being derived, in the decryption, from at least one of an input and an output of a function related to the Tweakable block cipher in each area; second tag generation means for generating, by using the set of random numbers and the nonce, a verification tag by a message authentication code using the Tweakable block cipher; and tag verification means for verifying whether tempering has occurred or not by comparing the verification tag with the input authentication tag, and performing control for outputting a verification result.

Further, an authenticated encryption method according to the present disclosure includes: encrypting a plaintext on an area-by-area basis by using a Tweakable block cipher using a nonce as a Tweak, the plaintext being divided into plaintext blocks each having a predetermined length, and each area having a predetermined length; generating a set of random numbers for each area by using first data and a predetermined matrix having predetermined values as its elements, the first data being derived, in the encryption, from at least one of an input and an output of a function related to the Tweakable block cipher in each area; and generating, by using the set of random numbers and the nonce, an authentication tag by a message authentication code using the Tweakable block cipher.

Further, an authenticated decryption method according to the present disclosure includes: decrypting a ciphertext on an area-by-area basis by using a Tweakable block cipher using a nonce as a Tweak, the ciphertext being divided into ciphertext blocks each having a predetermined length, and each area having a predetermined length; generating a set of random numbers for each area by using first data and a predetermined matrix having predetermined values as its elements, the first data being derived, in the decryption, from at least one of an input and an output of a function related to the Tweakable block cipher in each area; generating, by using the set of random numbers and the nonce, a verification tag by a message authentication code using the Tweakable block cipher; and verifying whether tempering has occurred or not by comparing the verification tag with an input authentication tag, and performing control for outputting a verification result.

Further, a program according to the present disclosure causes a computer to perform: a step of encrypting a plaintext on an area-by-area basis by using a Tweakable block cipher using a nonce as a Tweak, the plaintext being divided into plaintext blocks each having a predetermined length, and each area having a predetermined length; a step of generating a set of random numbers for each area by using first data and a predetermined matrix having predetermined values as its elements, the first data being derived, in the encryption, from at least one of an input and an output of a function related to the Tweakable block cipher in each area; and a step of generating, by using the set of random numbers and the nonce, an authentication tag by a message authentication code using the Tweakable block cipher.

Further, a program according to the present disclosure causes a computer to perform:
a step of decrypting a ciphertext on an area-by-area basis by using a Tweakable block cipher using a nonce as a Tweak, the ciphertext being divided into ciphertext blocks each having a predetermined length, and each area having a predetermined length;
a step of generating a set of random numbers for each area by using first data and a predetermined matrix having predetermined values as its elements, the first data being derived, in the decryption, from at least one of an input and an output of a function related to the Tweakable block cipher in each area;
a step of generating, by using the set of random numbers and the nonce, a verification tag by a message authentication code using the Tweakable block cipher; and
a step of verifying whether tempering has occurred or not by comparing the verification tag with an input authentication tag, and performing control for outputting a verification result.

### Advantageous Effects of Invention

According to the present disclosure, it is possible to provide an authenticated encryption apparatus, an authenticated decryption apparatus, and an authenticated encryption system, a method, and a computer readable medium capable of both increasing the number of plaintext blocks that can be processed in one authenticated encryption process and achieving high security.

### BRIEF DESCRIPTION OF DRAWINGS

FIG. 1 shows a configuration of an authenticated encryption apparatus according to a comparative example;

FIG. 2 shows a configuration of an authenticated encryption system according to a first example embodiment;

FIG. 3 shows a configuration of an authenticated encryption apparatus according to the first example embodiment;

FIG. 4 schematically shows calculation in authenticated encryption processing according to the first example embodiment;

FIG. 5 schematically shows calculation in authenticated encryption processing according to the first example embodiment;

FIG. 6 schematically shows calculation in authenticated encryption processing according to the first example embodiment;

FIG. 7 schematically shows calculation in authenticated encryption processing according to the first example embodiment;

FIG. 8 is a diagram for explaining functions of an authenticated encryption apparatus according to the first example embodiment;

FIG. 9 shows a configuration of an authenticated decryption apparatus according to the first example embodiment;

FIG. 10 schematically shows calculation in authenticated decryption processing according to the first example embodiment;

FIG. 11 schematically shows calculation in authenticated decryption processing according to the first example embodiment;

FIG. 12 is a diagram for explaining functions of an authenticated decryption apparatus according to the first example embodiment;

FIG. 13 is a flowchart showing an authenticated encryption method performed in an authenticated encryption apparatus according to the first example embodiment;

FIG. 14 is a flowchart showing an authenticated decryption method performed in an authenticated decryption apparatus according to the first example embodiment;

FIG. 15 shows a configuration of an authenticated encryption apparatus according to a second example embodiment;

FIG. 16 schematically shows calculation in authenticated encryption processing according to the second example embodiment;

FIG. 17 schematically shows calculation in authenticated encryption processing according to the second example embodiment;

FIG. 18 schematically shows calculation in authenticated encryption processing according to the second example embodiment;

FIG. 19 is a diagram for explaining functions of an authenticated encryption apparatus according to the second example embodiment;

FIG. 20 shows a configuration of an authenticated decryption apparatus according to the second example embodiment;

FIG. 21 shows a configuration of an authenticated encryption apparatus according to a third example embodiment;

FIG. 22 shows a configuration of an authenticated decryption apparatus according to the third example embodiment; and

FIG. 23 is a block diagram schematically showing an example of a hardware configuration of a calculation processing apparatus capable of implementing an apparatus or a system according to an example embodiment.

### EXAMPLE EMBODIMENT

### Outline of Example Embodiment According to Present Disclosure

Prior to describing an example embodiment according to the present disclosure, an outline of an example embodiment according to the present disclosure will be described. Note that although example embodiments according to the present disclosure will be described hereinafter, the following example embodiments are not intended to limit the invention specified by the claims. Further, not all combinations of features described in the example embodiments are essential for the means for solving the invention. Further, indices (alphabet) used in the following description may not be common throughout this specification. For example, an index i in one context and another index i in another context may refer to elements or the like different from each other.

Firstly, an outline of inputs and outputs of authenticated encryption (AE) will be described. Note that in the following description, communication between two persons, Alice and Bob, both of whom share (i.e., possess) a private key K, is assumed. Further, it is assumed that a message that has been encrypted by authenticated encryption is transmitted from Alice to Bob.

An encryption function and a decryption function of the authenticated encryption are represented by Enc and Dec, respectively. Further, a plaintext to be encrypted is represented by M, and a variable N (initial vector) called a Nonce is introduced. Further, associated data (AD; Associated Data) is represented by A. Note that the associated data A (header) is a value which is not encrypted, but it is detected whether or not this value has been tampered with.

Firstly, encryption processing on the Alice side will be described. After generating a nonce N, Alice carries out processing expressed as (C, T)=Enc_K (N, A, M). Note that Enc_K is an encryption function in which a key K, which is a private key, is used as a parameter, and C is a ciphertext. Further, T is a variable having a fixed length for detecting tampering, and is called a tag (authentication tag). Alice transmits a set of the nonce N, the associated data A, the ciphertext C, and the tag T (N, A, C, T) to Bob.

Next, decryption processing on the Bob side will be described. Information received by Bob is represented by (N′, A′, C′, T′). In this case, Bob carries out a function Dec_K (N′, A′, C′, T′) as decryption processing. Note that Dec_K is a decryption function in which the key K is used as a parameter. When tampering by a third party, Eve, has occurred during the communication and hence (N′, A′, C′, T′) is not equal to (N, A, C, T) ((N′, A′, C′, T′)/(N, A, C, T)), an error message (error symbol 1) indicating that the tampering has occurred for Dec_K (N′, A′, C′, T′) is output. That is, in this case, the tampering is detected. On the other hand, when no tampering has occurred during the communication and hence (N′, A′, C′, T′) is equal to (N, A, C, T) ((N′, A′, C′, T′)=(N, A, C, T)), the plaintext M encrypted by Alice is correctly decrypted by Dec_K (N′, A′, C′, T′).

Further, in the above-described processing, in general, it is important to prevent the nonce N from coinciding with any of its past values in the encryption. Therefore, on the encryption side, the nonce is prevented from coinciding with any of its past values by using some state variable such as a counter value. That is, typically, the nonce N that has been used in the last encryption is recorded as a state variable and this number N is incremented each time encryption is performed, so that the nonce N does not coincide with any of its past values.

Further, in Non-patent Literature 1, a block cipher called a Tweakable Block Cipher (TBC; Tweakable Block Cipher) in which a public adjustment value (supplementary variable) called a Tweak is introduced in encryption and decryption is used. That is, in the TBC, a keyed substitution (i.e., a substitution using a key) in which a Tweak is included in an input of a block cipher is performed. Then, TBCs of which the Tweaks are different from each other can be regarded as block ciphers independent of each other.

Note that when a Tweak is represented by Tw, the TBC function is expressed in the below-shown Expression 1.

$$\begin{matrix}[ Expression 1 ] & \\ {\tilde{E}}_{K}^{Tw} ( M ) = C & ( 1 )\end{matrix}$$

Note that in the following description, the left side (TBC function) of Expression 1 may be expressed as “E_K\hat{ }Tw^{˜}(M)” or “E_{K}^{Tw˜}(M)”, or simply as “E_{K}^{˜}” or “E_K^{˜}”.

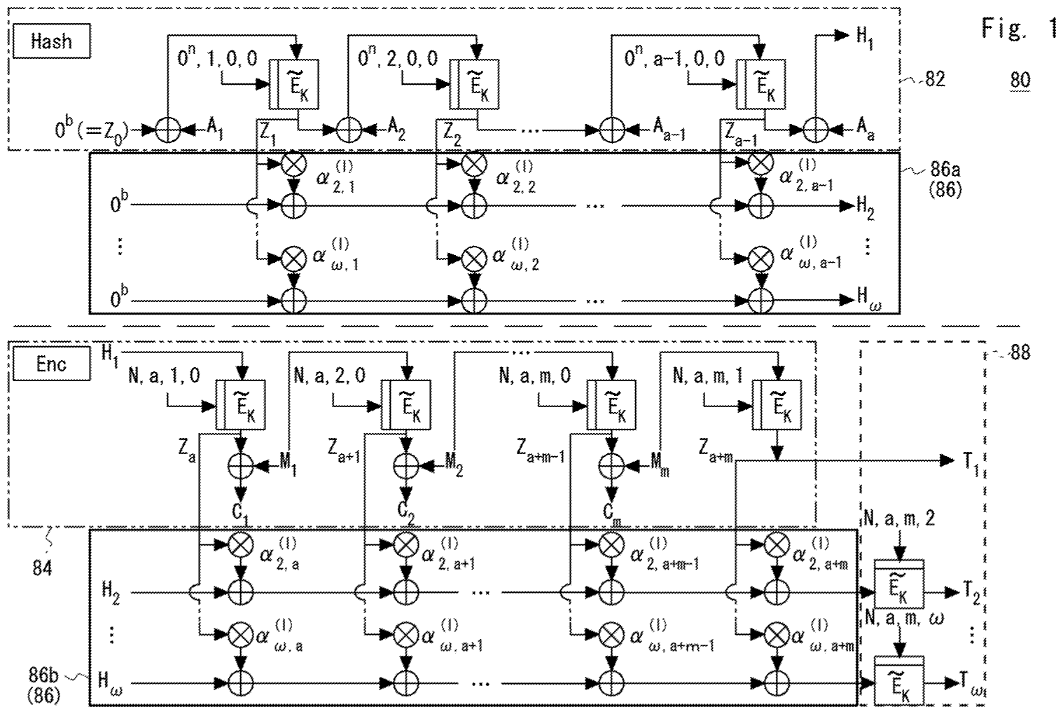

FIG. 1 shows a configuration of an authenticated encryption apparatus 80 according to a comparative example. FIG. 1 shows a configuration of an authenticated encryption apparatus 80 that is implemented by using an encryption method in PFBω disclosed in Non-patent Literature 1. Further, FIG. 1 shows an outline of calculation performed by the authenticated encryption apparatus 80 according to the comparative example.

The authenticated encryption apparatus 80 according to the comparative example includes an AD processing unit 82, an encryption unit 84, a calculation unit 86, and a tag generation unit 88. Note that although the calculation unit 86 is shown as a former-processing unit (first processing unit 86a) and a latter-processing unit (second processing unit) 86b separated from each other in FIG. 1 for the sake of convenience, the calculation unit 86 may be formed as one integrated component. That is, as the calculation unit 86, the former-processing unit 86a and the latter-processing unit 86b are formed in a continuous manner.

The AD processing unit 82 processes associated data (AD). The associated data A is input to the AD processing unit 82. The AD processing unit 82 divides the input associated data A into blocks (A_1, . . . , and A_a) each having a length of b bits. That is, each of the associated data (AD) blocks A_1, . . . , and A_a has a data length of b bits. Note that “a” indicates the number of AD blocks. The AD processing unit 82 processes each AD block by using a TBC function in which a key K and a Tweak are input.

Specifically, the AD processing unit 82 sets 0\hat{ }b(0^{b}) as an initial value Z_0 (Z₀). Note that 0\hat{ }b indicates that the b bits are all zeros (i.e., b-bits zeros). The AD processing unit 82 encrypts a value, obtained by an exclusive OR (XOR) of the initial value 0\hat{ }b (=Z_0) and the first AD block A_1 (i.e. a value obtained by XORing the initial value 0\hat{ }b (=Z_0) with the first AD block A_1), by the TBC function E_{K}^{˜}. In this way, a random number Z_1 is output form the TBC function E_{K}^{˜} as an encryption result. The AD processing unit 82 encrypts a value obtained by an exclusive OR of this output encryption result Z_1 and the second AD block A_2 by the TBC function E_{K}^{˜}. In this way, a value Z_2, which is a random number, is output from the TBC function E_{K}^{˜} as an encryption result. As described above, the AD processing unit 82 repeats the above-described process in which a value obtained by an exclusive OR of an output encryption result Z_i and the next (i+1)th block, i.e., the AD block A_(i+1), is encrypted by the TBC function E_{K}^{˜}. Note that 1≤i≥a.

Then, the AD processing unit 82 outputs a value obtained by an exclusive OR of the last AD block A_a and an encryption result Z_(a−1) to the encryption unit 84 as H_1. Note that H_1 is a b-bit value. Further, the AD processing unit 82 outputs the results of the encryption by the TBC functions, i.e., the random numbers Z_1, . . . , and Z_(a−1), which are the output values of the TBC function, to the calculation unit 86. Note that since Z is a value that is generated during the generation of H_1, it can be regarded as an intermediate value.

Note that for the security reason, the Tweak input to the TBC function needs to be in a format such as (0\hat{ }n, i, 0, 0) for a block index i (1≤i≤a) of the associated data A as shown in FIG. 1. Note that “0\hat{ }n(0ⁿ)” indicates n bits that are all zeros. Further, n indicates a data length (number of bits) of the nonce N. Note that although Tweaks input to a plurality of TBC functions are different from each other, Tweaks input to each TBC function (i.e., to a given TBC function) can be the same as each other even when different plaintexts are encrypted. That is, each of Tweaks input to the respective TBC functions can be a constant. For example, Tweaks (0ⁿ, 1, 0, 0) input to the first Eₖ⁻ can be the same as each other irrespective of whether one plaintext Ma is encrypted or another plaintext Mb is encrypted. Further, the same applies to Tweaks input to the TBC functions in the encryption unit 84 and the tag generation unit 88 (which will be described later), except for the value of the nonce.

Further, it is assumed that the data length of associated data A is a multiple of b bits. Note that if the length of Tweaks is increased, AD processing can be performed on associated data having an arbitrary length (i.e., a length that is not a multiple of b bits). However, this fact is obvious to researchers in this field, so the description thereof is omitted. This fact also applies to example embodiments described later. Further, there is a case where no associated data (AD) is included in the input of the AE (i.e., the associated data (AD) is empty). In that case, the AD processing unit 82 is not required. In that case, H_1 in the encryption unit 84 shown in FIG. 1 may be replaced by 0\hat{ }b.

The encryption unit 84 encrypts a plaintext. A nonce N, a plaintext M, and H_1 output from AD processing unit 82 are input to the encryption unit 84. The encryption unit 84 divides the input plaintext M into blocks (M_1, . . . , and M_m) each having a length of b bits. That is, each of the plaintext blocks M_1, . . . , and M_m has a data length of b bits. Note that m indicates the number of plaintext blocks. The encryption unit 84 processes each plaintext block by using a TBC function in which a key K, a nonce N, and a Tweak are input.

Specifically, the encryption unit 84 sets H_1 as an initial value. The encryption unit 84 encrypts the initial value H_1 by the TBC function E_{K}^{˜}. In this way, a random number Z_a is output form the TBC function E_{K}^{˜} as an encryption result. Then, the encryption unit 84 obtains a ciphertext block C_1 by an exclusive OR of this output encryption result Z_a and the first plaintext block M_1. Note that since Z is a value that is generated during the generation of a ciphertext block, it can be regarded as an intermediate value.

Next, the encryption unit 84 encrypts the plaintext block M_1 by the TBC function E_{K}^{˜}. In this way, Z_(a+1), which is a random number, is output as an encryption result. The encryption unit 84 obtains a ciphertext block C_2 by an exclusive OR of the encryption result Z_(a+1) and the second plaintext block M_2. As described above, the encryption unit 84 repeats the process in which a ciphertext block C_(i+1) is obtained by an exclusive OR of an encryption result Z_(a+i) of a plaintext block M_i of an ith block and a plaintext block M_(i+1) of the next (i+1)th block. Note that 0≤i≤m.

Then, when the last plaintext block M_m is encrypted by the TBC function E_{K}^{˜}, the encryption unit 84 outputs its encryption result Z_(a+m) to the tag generation unit 88 as T_1. Note that T_1 is a b-bit value and constitutes a part of a tag. Further, the encryption unit 84 outputs the generated ciphertext blocks C_1, . . . , and C_m as a ciphertext C=C_1∥ . . . ∥C_m. Note that “∥” indicates concatenation of bit strings. Further, the ciphertext C has a length (bit length) equal to that of the plaintext M. Further, the encryption unit 84 outputs the encryption results, i.e., the random numbers Z_a, . . . , and Z_(a+m), which are the output values of the TBC functions, to the calculation unit 86.

Note that for the security reason, the Tweak input to the TBC function needs to be in a format such as one shown in FIG. 1. That is, the encryption unit 84 encrypts M_i by using an encryption result of the TBC function in which (N, a, i, 0) is input as a Tweak for a block index i (1≤i≤m) of the plaintext M, and thereby obtains C_i. Note that the Tweak input to the TBC function that is used in the last process of the encryption unit 84 (i.e., the process in which M_m is input and T_1 is obtained) is (N, a, m, l). Further, as described above, although Tweaks input to a plurality of TBC functions are different from each other, Tweaks input to each TBC function (i.e., to a given TBC function) can be the same as each other, except for the value of the nonce N, even when different plaintexts are encrypted. That is, each of Tweaks input to the respective TBC functions can be a constant except for the value of the nonce N. Note that this feature also applies to example embodiments described later.

Further, similarly to the associated data, it is assumed that the data length of a plaintext M is a multiple of b bits. Note that if the length of Tweaks is increased, plaintext processing can be performed on a plaintext having an arbitrary length (i.e., a length that is not a multiple of b bits). However, this fact is obvious to researchers in this field, so the description thereof is omitted. Further, as described above, when no associated data (AD) is included in the input of the AE, H_1 may be replaced by 0\hat{ }b.

The calculation unit 86 receives the random numbers Z_1, . . . , Z_(a−1), Z_a, . . . , and Z_(a+m) generated in the AD processing unit 82 and the encryption unit 84. That is, all output values of the TBC functions in the AD processing unit 82 and the encryption unit 84 are input to the calculation unit 86. Then, the calculation unit 86 generates ω-1 values (i.e., ω-1 pieces of values) by using these random numbers and a predetermined matrix AM (Alpha Matrix).

Note that as shown in the below-shown Expression 2, the predetermined matrix AM is a matrix having a size (ω-1)×(a+m) in which the elements are predetermined values α_(i, j). Note that ω is a value indicating a predetermined security level and an integer of three or greater. Further, i is an index indicating the row in the matrix AM and corresponds to an index of a line. Note that 2≤i≤ω. Further, j is an index of the column in the matrix AM and corresponds to an index of an input random number Z, i.e., corresponds to a block index. Note that 1≤j≤a+m.

$$\begin{matrix}[ Expression 2 ] & \\ AM = ( \begin{matrix}{α}_{2 , 1} & ⋯ & {α}_{2 , a + m} \\ ⋮ & ⋱ & ⋮ \\ {α}_{ω , 1} & ⋯ & {α}_{ω , a + m}\end{matrix} ) & ( 2 )\end{matrix}$$

The calculation unit 86 generates H_2, . . . , and H_ω by processing the random numbers Z_1, . . . , Z_(a−1), Z_a, . . . , and Z_(a+m) by using the matrix AM as shown in the below-shown Expression 3.

$$\begin{matrix}[ Expression 3 ] & \\ ( \begin{matrix}{α}_{2 , 1} & ⋯ & {α}_{2 , a + m} \\ ⋮ & ⋱ & ⋮ \\ {α}_{ω , 1} & ⋯ & {α}_{ω , a + m}\end{matrix} ) ( \begin{matrix}{Z}_{1} \\ ⋮ \\ {Z}_{a + m}\end{matrix} ) = ( \begin{matrix}{H}_{2} \\ ⋮ \\ {H}_{ω}\end{matrix} ) & ( 3 )\end{matrix}$$

Further, based on Expression 3, the below-shown Expression 4 holds for each line i (2≤i≤ω).

$$\begin{matrix}[ Expression 4 ] & \\ {H}_{i} = {α}_{i , 1} \cdot {Z}_{1} ⊕ {α}_{i , 2} \cdot {Z}_{2} ⊕ … ⊕ {α}_{i , a + m} \cdot {Z}_{a + m} & ( 4 )\end{matrix}$$

Note that an element α_(i, j) of the matrix AM is an element (i.e., a member) of a finite field GF(2\hat{ }b). Further, an element α_(i, j) of the matrix AM is a specific value having b bits. Further, “.” of α_(i, j)·Z_j represents a multiplication over a finite field GF(2\hat{ }b), and is represented by a circled “×” in FIG. 1. Further, a circled “+” represents an exclusive OR (XOR).

That is, the calculation unit 86 calculates H_i by calculating, for each of ω-1 lines i (2≤i≤w), an exclusive OR of products of random numbers Z_j and α_(i, j). Note that in the comparative example (Non-patent Literature 1), the number of random numbers Z_j is increased from one to ω-1 in order to achieve high security. Therefore, it can be said that w means the increase number. Note that each of H_2, . . . , and H_ω is a b-bit value and used for a tag generation process. Further, the calculation unit 86 outputs the obtained H_2, . . . , and H_ω to the tag generation unit 88. Note that the predetermined matrix AM shown in Expression 2 needs to satisfy a certain condition for the security reason. Its details will be described later.

The tag generation unit 88 generates a tag T. T_1 is input from the encryption unit 84 to the tag generation unit 88, and H_2, . . . , and H_ω are input from the calculation unit 86 to the tag generation unit 88. Further, the nonce N is input to the tag generation unit 88. The tag generation unit 88 outputs T_1 as it is as a part of a tag. Further, the tag generation unit 88 encrypts each of H_2, . . . , and H_ω by using the TBC function in which the key K, the nonce N, and a Tweak, which is a constant, are input. As a result, T_2, . . . , and T_ω are obtained as encryption results. Then, the tag generation unit 88 outputs these encryption results as a tag. That is, the tag generation unit 88 outputs T_1, . . . , and T_ω as a tag T=T_1∥ . . . ∥T_ω.

Note that for the security reason, the Tweak input to the TBC function needs to be in a format such as one shown in FIG. 1. That is, the tag generation unit 88 encrypts, for an index i of H (2≤i≤m), H_i by using an encryption result of the TBC function in which (N, a, m, i) is input as a Tweak, and thereby obtains T_i. Further, as described above, although Tweaks input to a plurality of TBC functions are different from each other, Tweaks input to each TBC function (i.e., to a given TBC function) can be the same as each other, except for the value of the nonce N, even when different plaintexts are encrypted. That is, each of Tweaks input to the respective TBC functions can be a constant except for the value of the nonce N.

Problems in the comparison example will be described hereinafter. In the authenticated encryption processing (AE) according to the comparison example, the sum total of the number of AD blocks and the number of plaintext blocks, that can be processed all at once, needs to be (2\hat{ }b−1) or smaller due to the restriction in regard to the security. Note that when no associated data is input, the number of plaintext blocks that can be processed all at once needs to be (2\hat{ }b−2) or smaller due to the restriction in regard to the security. That is, when the sum total of the number of AD blocks and the number of plaintext blocks or the sum total of the number of plaintext blocks does not satisfy the above-described condition, the below-describe condition for the matrix AM of α_ij shown in Expression 2 cannot be satisfied due to the restriction in regard to the security.

That is, the matrix AM has to be a MDS (Maximum Distance Separable) matrix. That is, all minor determinants of the matrix AM that are square matrices need to be nonsingular matrices. Note that the “minor determinant” is a matrix that is formed by removing a specific row(s) (one or more than one) and a specific column(s) (one or more than one) from the original matrix. Further, currently, when the matrix AM does not satisfy the above-described condition, the security is unknown. Therefore, the matrix AM needs to be an MDS matrix.

Note that it can be mathematically proved that when the number of columns of the matrix AM exceeds 2\hat{ }b−1, there is no matrix that satisfies the above-described condition. Note that “2\hat{ }b−1” is the number of elements of a multiplicative group of finite fields GF(2\hat{ }b) (i.e., the number of b-bit values other than zero). Therefore, a relation “a+m≤2\hat{ }b−1” has to hold. Note that when the associated data (AD) is empty, a relation “m≤2\hat{ }b−2” needs to hold because of the difference between the AD processing and the encryption processing as described hereinafter.

That is, when the associated data is not empty, in order to process the associated data A of a AD blocks (i.e., a pieces of AD blocks), it is necessary to prepare a matrix AM of which the number of columns is a−1 for the matrix AM shown in Expression 2. This is because, as shown in FIG. 1, AD blocks can be processed before and after the TBC function. That is, the first AD block A_1 is processed before the processing of the first TBC function, and the second AD block A_2 is processed after this TBC function. Further, the second AD block A_2 is processed before the processing of the second TBC function, and the third AD block A_3 is processed after this TBC function. After that, the above-described processes are repeated, and eventually the (a−1)th AD block A_(a−1) is processed before the processing of the (a−1)th TBC function, and the ath AD block A_a, i.e., the last AD block A_a, is processed after this TBC function.

Further, in order to process a plaintext M consisting of m plaintext blocks, as shown in FIG. 1, it is necessary to prepare a matrix AM of which the number of columns is m+1 for the matrix AM shown in Expression 2. This is because, as shown in FIG. 1, it is necessary to generate a ciphertext block C_m by using an mth TBC function and an mth plaintext block M_m (i.e., the last plaintext block M_m), and then process this mth plaintext block M_m by an (m+1)th TBC function. Therefore, when the associated data is not empty, a relation “(a−1)+(m+1)≤2\hat{ }b−1”, i.e., a relation “a+m≤2\hat{ }b−1”, needs to hold. That is, when the relation “a+m≤2\hat{ }b−1” holds in the matrix AM shown in Expression 2, it is also possible to carry out AE processing in the PFBω according to the comparative example (Non-patent Literature 1). On the other hand, when the associated data is empty, a relation “m+1≤2\hat{ }b−1”, i.e., a relation “m≤2\hat{ }b−2”, needs to hold. That is, when the relation “m≤2\hat{ }b−2” holds in the matrix AM shown in Expression 2, it is also possible to carry out the AE processing in the PFBω according to the comparative example (Non-patent Literature 1).

As described above, in the PFBω according to the comparative example (Non-patent Literature 1), there is a limit on the number of blocks (number of plaintext blocks, or sum total of number of AD blocks and number of plaintext blocks) that can be processed all at once. Note that in the PFBω, as described above, relatively high security, i.e., security of ωb bits, can be achieved. Therefore, ideally, it is desirable if the length of a plaintext that can be processed for an input in one AE process is about 2\hat{ }(ωb) blocks. However, in the PFBω, the limit on the number of input blocks is the same as that in the case of AE in which the security is b bits, so that the efficiency is poor.

In contrast, in the authenticated encryption according to this example embodiment, it is possible to increase the number of plaintext blocks that can be processed in one authenticated encryption process and to achieve high security at the same time as described hereinafter. That is, in the authenticated encryption according to this example embodiment, it is possible to achieve security higher than security of b bits by using b-bit input/output TBC functions and to process at least (2\hat{ }b−1) blocks. Note that in this example embodiment, it is possible to achieve a security level higher than security of 2b bits.

### First Example Embodiment

An example embodiment will be described hereinafter with reference to the drawings. For the sake of clarifying the explanation, the following descriptions and drawings are omitted and simplified as appropriate. Further, the same elements are assigned the same reference numerals (or symbols) throughout the drawings, and redundant descriptions are omitted as appropriate. Note that an authenticated encryption method according to a first example embodiment corresponds to a configuration that is obtained by improving the above-described PFBω according to the comparative example (Non-patent Literature 1).

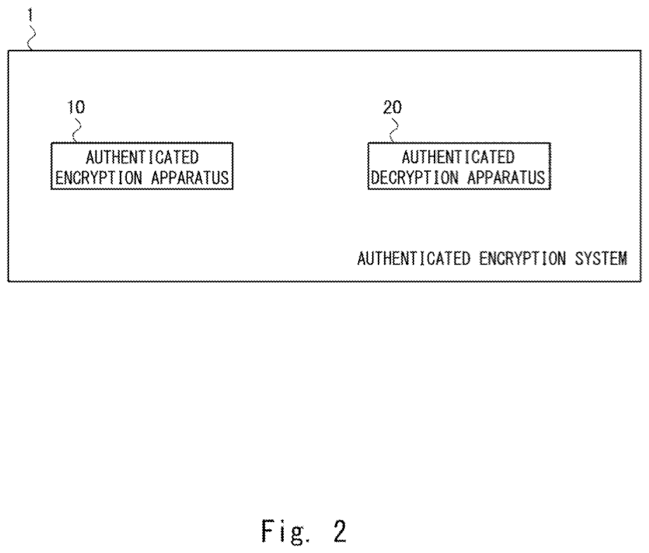

FIG. 2 shows a configuration of an authenticated encryption system 1 according to the first example embodiment. The authenticated encryption system 1 includes an authenticated encryption apparatus 10 and an authenticated decryption apparatus 20. The authenticated encryption apparatus 10 and the authenticated decryption apparatus 20 may be physically-integrated one apparatus, or may be apparatuses physically separated from each other. When the authenticated encryption apparatus 10 and the authenticated decryption apparatus 20 are physically separated from each other, the authenticated encryption apparatus 10 and the authenticated decryption apparatus 20 are connected to each other through a wire or wirelessly so that they can communicate with each other. Further, components of the authenticated encryption apparatus 10 (which will be described later) may be implemented in a plurality of apparatuses separated from each other. Similarly, components of the authenticated decryption apparatus 20 (which will be described later) may be implemented in a plurality of apparatuses separated from each other.

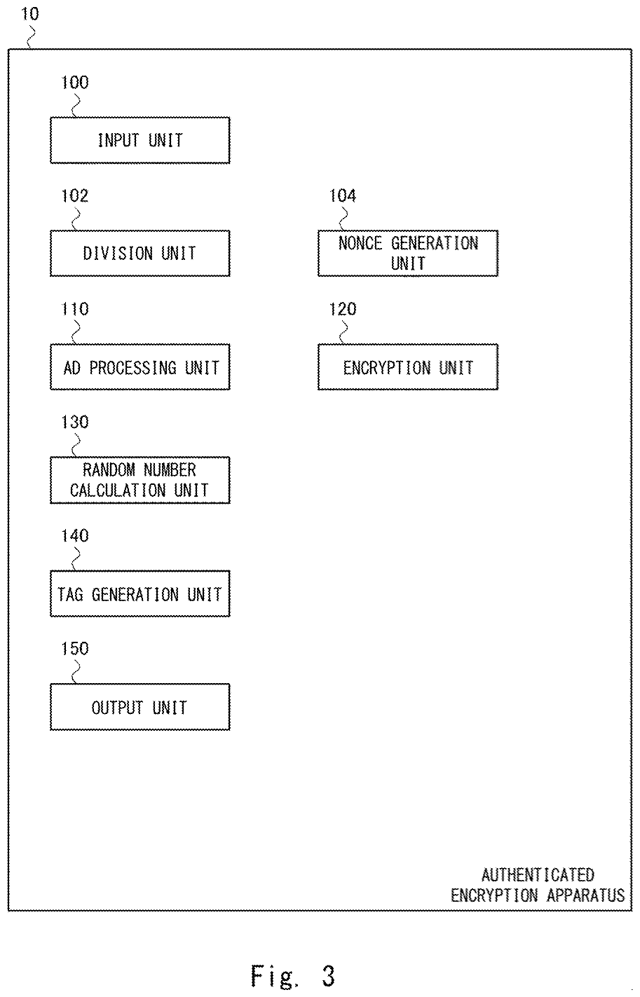

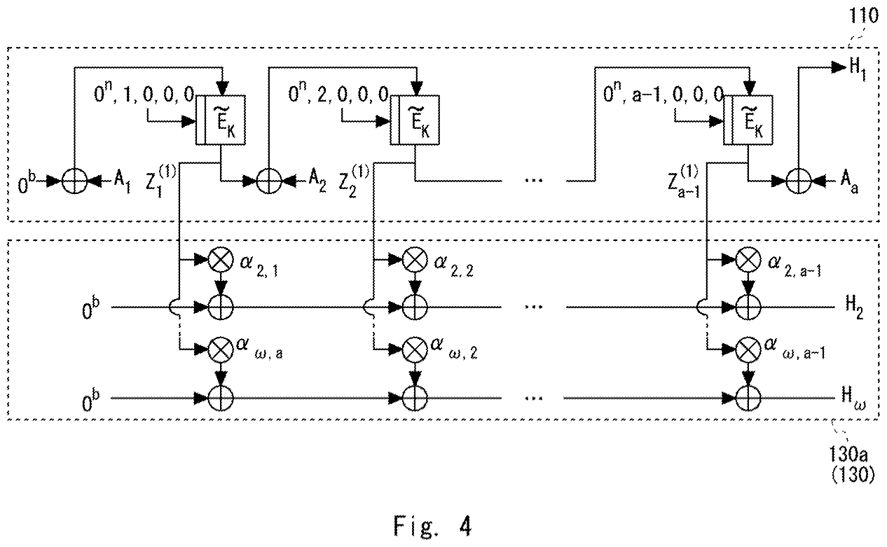

Note that in the following description, unless otherwise specified, it is assumed that the length of each of a plurality of blocks obtained by dividing associated data A, a plaintext M, a ciphertext C, or the like is a predetermined length of b bits. Further, the authenticated encryption apparatus 10 corresponds to Alice in the above-described example of communication between Alice and Bob, and the authenticated decryption apparatus 20 corresponds to Bob in the above-described example. That is, communication is performed between the authenticated encryption apparatus 10 and the authenticated decryption apparatus 20.

<Authenticated Encryption Apparatus> FIG. 3 shows a configuration of the authenticated encryption apparatus 10 according to the first example embodiment. Further, FIGS. 4 to 7 show an outline of calculation in authenticated encryption processing according to the first example embodiment. As shown in FIG. 3, the authenticated encryption apparatus 10 includes an input unit 100, a division unit 102, a nonce generation unit 104, an AD processing unit 110, an encryption unit 120, a random number calculation unit 130, a tag generation unit 140, and an output unit 150.

The authenticated encryption apparatus 10 can be implemented, for example, by an information processing apparatus such as a computer. That is, the authenticated encryption apparatus 10 includes a calculation apparatus such as a CPU (Central Processing Unit) and a storage device such as a memory or a disk. The authenticated encryption apparatus 10 implements each of the above-described components, for example, by having the calculation apparatus execute a program(s) stored in the storage device. This feature also applies to other example embodiments described later.

The input unit 100 functions as input means. The division unit 102 functions as division means. The nonce generation unit 104 functions as nonce generation means. The AD processing unit 110 functions as associated-data processing means. The encryption unit 120 functions as encryption means. The random number calculation unit 130 functions as random number calculation means (calculation means). The tag generation unit 140 functions as tag generation means. The output unit 150 functions as output means.

The input unit 100 receives an input of a plaintext M to be encrypted and associated data A. The input unit 100 may be implemented, for example, by an input device such as a keyboard. The input unit 100 may receive an input of a plaintext M and associated data A from, for example, an external apparatus connected thereto through a network. Note that in some cases, there is no associated data A, and in such cases, no associated data A is input. The input unit 100 outputs the plaintext M and the associated data A to the division unit 102.

The division unit 102 divides each of the plaintext M and the associated data A into blocks each having a predetermined length. Specifically, the division unit 102 divides the plaintext M into b-bit plaintext blocks M_1, . . . , and M_m. Note that m is the number of plaintext blocks. The division unit 102 outputs the plaintext blocks M_1, . . . , and M_m to the encryption unit 120.

Further, the division unit 102 divides the associated data A into AD blocks A_1, . . . , and A_a each having a length of b bits. Note that “a” is the number of AD blocks. The division unit 102 outputs the AD blocks A_1, . . . , and A_a to the AD processing unit 110.

Further, the division unit 102 groups (or divides) the divided AD blocks A_1, . . . , and A_a and the divided plaintext blocks M_1, . . . , and M_m into areas (groups) each of which contains (2\hat{ }b−2) blocks. That is, each area (i.e., segment) contains (2\hat{ }b−2) blocks. Here, the areas are referred to as areas #1, . . . , and #β, respectively. Note that β is the number of areas. An area #k represents a kth area. Note that 1≤k≤B. Note that the division unit 102 may group a data string D=A_1∥ . . . ∥A_a∥M_1∥ . . . ∥M_m into areas so that they are grouped, from the first block of the data string, in the order of an area #1, area #2, . . . , and area #β.

Specifically, the division unit 102 groups the blocks (i.e., performs the segmentation of the blocks) so that all the AD blocks A_1, . . . , and A_a are included in the area #1. Further, in the case of a<2\hat{ }b−2, the division unit 102 groups the blocks (i.e., performs the segmentation of the blocks) so that m′ plaintext blocks (i.e., m′ pieces of plaintext blocks) are included in the area #1. Note that m′ is the number of plaintext blocks included in the area #1 (first area). Further, m′ satisfies a relation “a+m′=2\hat{ }b−2”. Further, it should be noted that m is larger than m′ (m>m′) in the first example embodiment.

Then, the division unit 102 groups (or divides) the remaining (m-m′) plaintext blocks (i.e., (m-m′) pieces of plaintext blocks) into the areas #2 to #β. The following description will be given on the assumption that a relation “a<2\hat{ }b−2” holds, unless otherwise specified. Note that β is a value that is determined according to the number a of AD blocks, the number m of plaintext blocks, and the value of 2\hat{ }b−2 (i.e., the value of b). That is, when (a+m)mod(2\hat{ }b−2)=0, B corresponds to the quotient of the division (a+m)/(2\hat{ }b−2). On the other hand, when (a+m)mod(2\hat{ }b−2)+0, β corresponds to a value that is obtained by adding one to the quotient of the division (a+m)/(2\hat{ }b−2).

Note that when a=2\hat{ }b−2, all of (2\hat{ }b−2) blocks grouped in the area #1 become AD blocks. Then, the division unit 102 groups (2\hat{ }b-2) plaintext blocks from the first block of the data string D=M_1∥ . . . ∥M_m into the area #2.

Further, when a>2\hat{ }b-2, all of (2\hat{ }b-2) blocks grouped into the area #1 become AD blocks. Then, the remaining AD blocks are grouped into the area #2. Then, when all the AD blocks A_1, . . . , and A_a are grouped into the areas #1 and #2, the plaintext blocks are grouped into the area #2 so that the sum total of the AD blocks and the plaintext blocks grouped into the area #2 becomes (2\hat{ }b-2). Note that when the number of the plaintext blocks grouped into the area #2 is represented by m″, a relation “a+m″=2×(2\hat{ }b-2)” holds. Note that when the grouping (i.e., dividing) of all the AD blocks has not been completed even after the AD blocks are grouped into the areas #1 and #2, the remaining AD blocks are grouped into the area #3 in a similar manner.

Note that when the associated data is empty, the division unit 102 groups the data string D=M_1∥ . . . ∥M_m into areas so that they are grouped, from the first block of the data string, in the order of an area #1, area #2, . . . , and area #β. Note that when the number of the plaintext blocks grouped into the area #1 is represented by m′, a relation “m′=2\hat{ }b-2” holds. Note that when the bit string of plaintext blocks grouped into an area #k is expressed as an “area plaintext block M[k]”, the plaintext M can also be expressed as M=M[1]∥M[2]∥ . . . ∥M[β]. Then, the number of plaintext blocks included in each of area plaintext blocks M[k] other than at least M[1] and M[β] becomes (2\hat{ }b-2). Further, when the associated data is empty, the number of plaintext blocks included in the area plaintext block M[1] also becomes (2\hat{ }b-2).

Note that by grouping (or dividing) blocks (AD blocks and plaintext blocks) into areas each containing (2\hat{ }b-2) blocks, it is possible to perform encryption and random number calculation for each area by using the technique of PFBω according to the comparative example as described later. In this way, it is possible to achieve the security in the PFBω without being restricted by the limitation on the number of blocks, which causes the problem in PFBω.

Note that it has been stated in the above description that when the associated data is not empty, the relation “a+m≤2\hat{ }b-1” needs to hold, whereas when the associated data is empty, the relation “m≤2\hat{ }b-2” needs to hold. However, in order to prevent the processing from becoming complicated, the number of blocks in each area is set to (2\hat{ }b-2) in the first example embodiment. Therefore, in the first example embodiment, encryption and random number calculation are performed for each of (2\hat{ }b-2) blocks (areas) as described later. In this way, in the first example embodiment, even when a+m>2\hat{ }b-1, authenticated encryption can be performed on the plaintext M all at once. Its details will be described later.

The nonce generation unit 104 generates a nonce N in such a manner that the generated nonce does not coincide with any of its past values. That is, the nonce generation unit 104 generates a nonce N that is different from any of its past values. Specifically, for example, the nonce generation unit 104 first outputs an arbitrary fixed value. Further, the nonce generation unit 104 records the value of the nonce generated the last time (i.e., immediately before). Then, when the nonce generation unit 104 generates a nonce N the second time or later, it outputs a value that is obtained by adding one to the recorded last value. As described above, the nonce generation unit 104 may generate a nonce N different from any of the values generated in the past by outputting a value obtained by adding one to the value that was already output immediately before (i.e., output the last time). Note that the nonce generation unit 104 may generate a nonce by a method different from the above-described example, provided that it can generate a value different from any of the values generated in the past. The nonce generation unit 104 outputs the generated nonce N to the encryption unit 120 and the tag generation unit 140. Further, the nonce generation unit 104 may output the generated nonce N to the output unit 150.

The AD processing unit 110 processes the associated data A in a manner similar to that in the AD processing unit 82 shown in FIG. 1. That is, the AD processing unit 110 processes the AD blocks A_1, . . . , and A_a by using the TBC function in which a key K and a Tweak are input. In this process, the AD processing unit 110 processes the AD blocks on an area-by-area basis as described above. Note that when a<2\hat{ }b-2, the processing performed by the AD processing unit 110 is substantially the same as that performed by the AD processing unit 82. The AD processing unit 110 outputs H_1 to the encryption unit 120. Further, the AD processing unit 110 outputs random numbers Z_1, . . . , and Z_(a−1), which are the output values of the TBC functions, to the random number calculation unit 130.

Note that the Tweak input to each of the TBC functions used in the AD processing unit 110 may be different from the Tweak input to each of the TBC functions used in the AD processing unit 82. Its details will be described later.

The encryption unit 120 processes the plaintext M in a manner similar to that in the encryption unit 84 shown in FIG. 1. That is, the encryption unit 120 processes the plaintext blocks M_1, . . . , and M_m by using the TBC function in which the key K and the Tweak are input. Then, the encryption unit 120 generates a ciphertext block by an exclusive OR of the plaintext block and the encryption result obtained by encrypting a plaintext block preceding this plaintext block by using the TBC function. In this process, the encryption unit 120 encrypts plaintext blocks (plaintext) on an area-by-area basis as described above. That is, the encryption unit 120 encrypts plaintext blocks included in the area #1 in a manner similar to that in the encryption unit 84. Then, the encryption unit 120 encrypts plaintext blocks included in the area #2 in a manner similar to that in the encryption unit 84. After that, the encryption unit 120 encrypts plaintext blocks included in an area #k in a manner similar to that in the encryption unit 84. That is, the encryption unit 120 encrypts an area plaintext block M[k] included in an area #k.

The encryption unit 120 outputs the generated ciphertext blocks C_1, . . . , and C_m to the output unit 150 as a ciphertext C=C_1∥ . . . ∥C_m. Further, the encryption unit 120 obtains an area ciphertext block C[k] by encrypting an area plaintext block M[k] included in an area #k. Note that the area ciphertext block C[k] consists of the same number of ciphertext blocks as the number of plaintext blocks of the area plaintext block M[k]. The encryption unit 120 outputs a random number Z (output value of the TBC function) obtained in each area to the random number calculation unit 130. Further, the encryption unit 120 outputs an encryption result Z obtained by processing the last plaintext block by the TBC function in each area to the tag generation unit 140 as a random number S_1. Details of the processing of the encryption unit 120 will be described later.

Note that the Tweak input to each of the TBC functions used in the encryption unit 120 may be different from the Tweak input to each of the TBC functions used in the encryption unit 84. Its details will be described later. Note that in order to distinguish Tweaks input to TBC functions used in the AD processing, the encryption processing and the like, which are performed on an area-by-area basis, from each other, the number of digits of a Tweak in the first example embodiment is larger than the number of digits of a Tweak in the comparative example. That is, while processing is performed in only one area in the comparative example, processing is performed for a plurality of areas in the first example embodiment, so that it is necessary to increase the number of digits of Tweaks in order to distinguish Tweaks from each other.

Similarly to the calculation unit 86 shown in FIG. 1, the random number calculation unit 130 calculates a value (random number) for generating a tag by using random numbers Z generated by the AD processing unit 110 and the encryption unit 120 and a predetermined matrix AM. Note that the matrix AM according to the first example embodiment is shown in the below-shown Expression 5. Note that the matrix AM is a matrix having a size (ω-1)×(2\hat{ }b-1) in which the elements are predetermined values α_(i, j).

$$\begin{matrix}[ Expression 5 ] & \\ AM = ( \begin{matrix}{α}_{2 , 1} & ⋯ & {α}_{2 , {2}^{b} - 1} \\ ⋮ & ⋱ & ⋮ \\ {α}_{ω , 1} & ⋯ & {α}_{ω , {2}^{b} - 1}\end{matrix} ) & ( 5 )\end{matrix}$$

The random number calculation unit 130 calculates random numbers S for each area. Specifically, the random number calculation unit 130 generates, for each area, a set of ω-1 random numbers S (S_2, . . . , and S_ω) by using random numbers Z generated by the AD processing unit 110 and the encryption unit 120 and the predetermined matrix AM. Note that the set of random numbers S is used to generate a tag T. The random number calculation unit 130 calculates, for each area, S_i by calculating an exclusive OR of products of random numbers Z_j and α_(i, j) for each of ω-1 lines i (2≤i≥ω).

That is, in each area #k, the random number calculation unit 130 generates a set of random numbers S_2\hat{ }(k), . . . , and S_ω\hat{ }(k) by processing the random numbers Z_1\hat{ }(k), . . . , and Z_(2\hat{ }b-1)\hat{ }(k) by using the matrix AM as shown in the below-shown Expression 6. That is, the random number calculation unit 130 generates a set of random numbers for each area #k by using the same matrix AM as that shown in Expression 5. Note that k is an index of the area number.

$$\begin{matrix}[ Expression 6 ] & \\ ( \begin{matrix}{α}_{2 , 1} & ⋯ & {α}_{2 , {2}^{b} - 1} \\ ⋮ & ⋱ & ⋮ \\ {α}_{ω , 1} & ⋯ & {α}_{ω , {2}^{b} - 1}\end{matrix} ) ( \begin{matrix}{Z}_{1}^{( k )} \\ ⋮ \\ {Z}_{{2}^{b} - 1}^{( k )}\end{matrix} ) = ( \begin{matrix}{S}_{2}^{( k )} \\ ⋮ \\ {S}_{ω}^{( k )}\end{matrix} ) & ( 6 )\end{matrix}$$

Note that based on Expression 6, the below-shown Expression 7 holds for i (2≤i≤ω).

$$\begin{matrix}[ Expression 7 ] & \\ {S}_{i}^{( k )} = {α}_{i , 1} \cdot {Z}_{1}^{( k )} ⊕ {α}_{i , 2} \cdot {Z}_{2}^{( k )} ⊕ … ⊕ {α}_{i , {2}^{b} - 1} \cdot {Z}_{{2}^{b} - 1}^{( k )} & ( 7 )\end{matrix}$$

Note that the random number calculation unit 130 initializes (i.e., resets), for each area, the initial value of each line of the exclusive OR of products of Z and α. That is, the random number calculation unit 130 sets the initial value of a line i to 0\hat{ }b for each area. In other words, the random number calculation unit 130 initializes (i.e., resets), for each area, the initial value of each of a plurality of lines in which a set of random numbers is generated. Details of the processing performed by the random number calculation unit 130 will be described later. The random number calculation unit 130 outputs the set of random numbers S_1\hat{ }(k), . . . , and S_ω\hat{ }(k) generated for each area #k to the tag generation unit 140. Note that as described above, the random number S_1\hat{ }(k) in each area #k is generated by the encryption unit 120 and output to the tag generation unit 140.

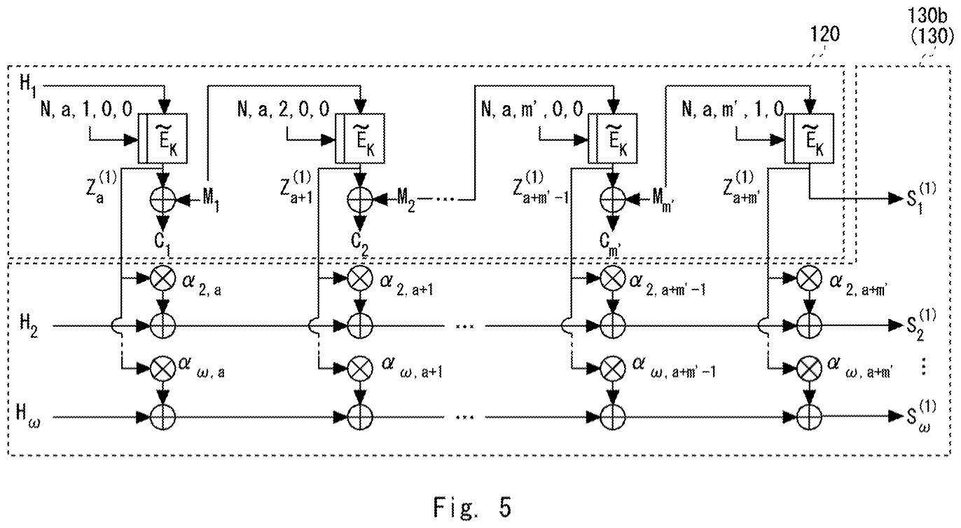

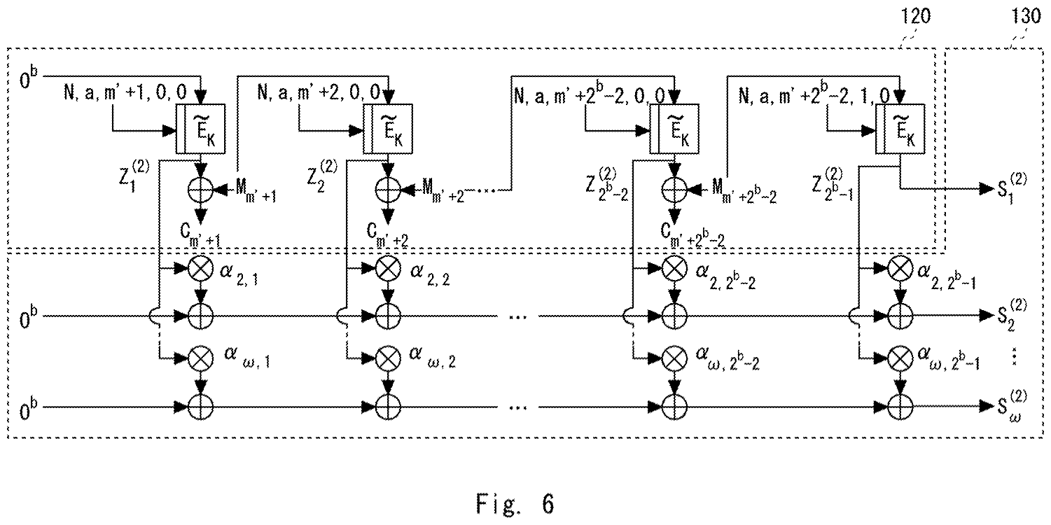

FIG. 4 shows an outline of calculation performed by the AD processing unit 110 and the random number calculation unit 130 for the first area, i.e., for the area #1. Further, FIG. 5 shows an outline of calculation performed by the encryption unit 120 and the random number calculation unit 130 for the first area, i.e., for the area #1. Further, FIG. 6 shows an outline of calculation performed by the encryption unit 120 and the random number calculation unit 130 for the second area, i.e., for the area #2. Note that the random number calculation unit 130 is shown as a former-processing unit 130a and a latter-processing unit 130b separated from each other in FIGS. 4 and 5 for the sake of convenience, the random number calculation unit 130 may be formed as one integrated component. That is, as the random number calculation unit 130, the former-processing unit 130a and the latter-processing unit 130b are formed in a continuous manner. In fact, the random number calculation unit 130 is shown as one integrated component in FIG. 6.

As shown in FIG. 4, the AD processing unit 110 performs, for the area #1, substantially the same processing as that performed by the AD processing unit 82 shown in FIG. 1 for AD blocks A_1, . . . , and A_a. Then, the AD processing unit 110 outputs the encryption result, i.e., the random numbers Z_1\hat{ }(1), . . . and Z_(a−1)\hat{ }(1), which are the output values of the TBC functions, to the random number calculation unit 130. Note that as described above, k of Z_j\hat{ }(k) is an index of the area number. That is, “(1)” of the random number Z_1\hat{ }(1) indicates that it is a random number generated in the area #1 (first area). Further, the AD processing unit 110 outputs a value that is obtained by an exclusive OR of the last AD block A_a and the encryption result Z_(a−1)\hat{ }(1) to the encryption unit 120 as H_1. Note that since the relation “a<2\hat{ }b-2” holds in the example shown in FIGS. 4 to 6, the AD processing unit 110 performs processing only for the area #1.

Further, as shown in FIG. 5, the encryption unit 120 performs, for the area #1, substantially the same processing as that performed by the encryption unit 84 shown in FIG. 1 for, among the plaintext blocks M_1, . . . , and M_m, plaintext blocks M_1, . . . , and M_m′. Then, the encryption unit 120 obtains ciphertext blocks C_1, . . . , and C_m′ corresponding to the plaintext blocks M_1, . . . , and M_m′, respectively. Further, the encryption unit 120 outputs the encryption result, i.e., the random numbers Z_a\hat{ }(1), . . . , and Z_(a+m′)\hat{ }(1), which are the output values of the TBC functions, to the random number calculation unit 130. Note that the encryption unit 120 obtains the last random number Z_(a+m′)\hat{ }(1) in the area #1 by encrypting the last plaintext block M_m′ in the area #1 by the last TBC function in the area #1. Further, when the last plaintext block M_m′ is encrypted by the TBC function, the encryption unit 120 outputs the encryption result Z_(a+m′)\hat{ }(1) to the random number calculation unit 130 as S_1\hat{ }(1).

Note that as described above, the Tweak input to each of the TBC functions used in the AD processing unit 110 and the encryption unit 120 is different from the Tweak input to each of the TBC functions used in the AD processing unit 82 and the encryption unit 84. The Tweak input to the TBC function used in the AD processing unit 110 is (0\hat{ }n, i, 0, 0, 0) for a block index i (1≤i≤a) of the associated data A. Further, the Tweak input to the TBC function used in the encryption unit 120 is (N, a, i, 0, 0) for a block index i (1≤i≤m′) of the plaintext M. Note that for the area #1, the Tweak input to the TBC function used in the last process performed by the encryption unit 120 (i.e., the TBC function into which M_m′ is input and from which S_1\hat{ }(1) is obtained) is (N, a, m′, l, 0). By setting the Tweak as described above, no Tweak coincides with any of the other Tweaks.

Further, as shown in FIGS. 4 and 5, the random number calculation unit 130 processes, for the area #1, the random numbers Z_1\hat{ }(1), . . . , Z_(a−1)\hat{ }(1), Z_a\hat{ }(1), . . . , and Z_(a+m′)\hat{ }(1) generated by the AD processing unit 110 and the encryption unit 120. That is, according to the above-shown Expression 6, the random number calculation unit 130 processes the random numbers Z_1\hat{ }(1), . . . , Z_(a−1)\hat{ }(1), Z_a\hat{ }(1), . . . , and Z_(a+m′)\hat{ }(1) by using the matrix AM shown in Expression 5. In this way, the random number calculation unit 130 generates a set of random numbers S_2\hat{ }(1), . . . , and S_ω\hat{ }(1) for the area #1. In other words, the random number calculation unit 130 generates a set of random numbers S_2\hat{ }(1), . . . , and S_ω\hat{ }(1) by calculating exclusive ORs of products of the random numbers Z_1\hat{ }(1), . . . , and Z_(a+m′)\hat{ }(1) and the corresponding elements of the matrix AM. The random number calculation unit 130 outputs the set of random numbers S_1\hat{ }(1), . . . , and S_ω\hat{ }(1) generated for the area #1 to the tag generation unit 140.

Note that the relation a+m′=2\hat{ }b-2 holds as described above. That is, the last random number Z_(a+m′)\hat{ }(1) in the area #1 corresponds to Z_(2\hat{ }b-2)\hat{ }(1). Therefore, in the above-shown Expression 6, a relation “Z_(2\hat{ }b-1)\hat{ }(1)=0” holds for the area #1. That is, the last column (α_(2, 2\hat{ }b-1), . . . α_(ω, 2\hat{ }b-1)) of the matrix AM shown in the above-shown Expression 5 is not used for the area #1. That is, in the area #1, in the last exclusive OR in the above-shown Expression 7, the exclusively OR of 0 (=α_(i, 2\hat{ }b-1)·Z_(2\hat{ }b-1)\hat{ }(1)) is calculated (i.e., 0 (=α_(i, 2\hat{ }b-1)·Z_(2\hat{ }b-1)\hat{ }(1)) is XORed). This also applies to decryption processing performed by the authenticated decryption apparatus 20 (which will be described later).

Further, as shown in FIG. 6, the encryption unit 120 performs, for the area #2, processing similar to that for the area #1 for, among the plaintext blocks M_1, . . . , and M_m, (2\hat{ }b-2) M_(m′+1), . . . , and M_(m′+2\hat{ }b-2), which follow M_m′. Note that the encryption unit 120 initializes (i.e., resets), for the area #2, the initial value input to the first TBC function to 0\hat{ }b. Then, the encryption unit 120 obtains ciphertext blocks C_(m′+1), . . . , and C_(m′+2\hat{ }b-2) corresponding to the plaintext blocks M_(m′+1), . . . , and M_(m′+2\hat{ }b-2), respectively. Further, the encryption unit 120 outputs the encryption result, i.e., the random numbers Z_1\hat{ }(2), . . . , and Z_(2\hat{ }b-1)\hat{ }(2), which are the output values of the TBC functions, to the random number calculation unit 130. Note that the encryption unit 120 obtains the last random number Z_(2\hat{ }b-1)\hat{ }(2) in the area #2 by encrypting the last plaintext block M_(m′+2\hat{ }b-2) in the area #2 by the last TBC function in the area #2. Further, when the last plaintext block M_(m′+2\hat{ }b-2) is encrypted by the TBC function, the encryption unit 120 outputs the encryption result Z_(2\hat{ }b-1)\hat{ }(2) to the random number calculation unit 130 as S_1\hat{ }(2).

Further, as shown in FIG. 6, the random number calculation unit 130 processes, for the area #2, the random numbers Z_1\hat{ }(2), . . . , and Z_(2\hat{ }b-1)\hat{ }(2) generated by the encryption unit 120. That is, according to the above-shown Expression 6, the random number calculation unit 130 processes the random numbers Z_1\hat{ }(2), . . . , and Z_(2\hat{ }b-1)\hat{ }(2) by using the matrix AM shown in Expression 5. In this way, the random number calculation unit 130 generates a set of random numbers S_2\hat{ }(2), . . . , and S_ω\hat{ }(2) for the area #2. In other words, the random number calculation unit 130 generates a set of random numbers S_2\hat{ }(2), . . . , and S_ω\hat{ }(2) by calculating exclusive ORs of products of the random numbers Z_1\hat{ }(2), . . . , and Z_(2\hat{ }b-1)\hat{ }(2) and the corresponding elements of the matrix AM. Note that the random number calculation unit 130 initializes (i.e., resets), for the area #2, the initial value of each line i to 0\hat{ }b. The random number calculation unit 130 outputs the set of random numbers S_1\hat{ }(2), . . . , and S_ω\hat{ }(2) generated for the area #2 to the tag generation unit 140.

Note that as described above, the Tweak input to each of the TBC functions used in the encryption unit 120 is different from the Tweak input to each of the TBC functions used in the encryption unit 84. In the area #2, the Tweak input to the TBC function used in the encryption unit 120 is (N, a, i, 0, 0) for a block index i (m′+1≤i≤m′+2\hat{ }b-2) of the plaintext M. Note that for the area #2, the Tweak input to the TBC function used in the last process performed by the encryption unit 120 (i.e., the TBC function into which M_(m′+2\hat{ }b-2) is input and from which S_1\hat{ }(2) is obtained) is (N, a, m′+2\hat{ }b-2, 1, 0). In this way, the Tweak input to each of the TBC functions in the area #2 is different from the Tweak input to each of the TBC functions in the area #1. The same applies to the decryption processing performed by the authenticated decryption apparatus 20 (which will be described later).

Note that although an outline of calculation for the areas #1 and #2 is shown in FIGS. 4 to 6, substantially the same calculation as that for the area #2 shown in FIG. 6 is performed for the area #3 and for the subsequent areas. Therefore, the description of specific processing for the area #3 and for the subsequent areas is omitted. Note that each time processing is performed for a given area, the random number calculation unit 130 initializes (i.e., resets) the initial value of each line, repeatedly calls the same matrix AM (i.e., the same elements a) as that shown in Expression 5, and thereby generates a set of random numbers.

Note that the Tweak input to each of the TBC functions used in the encryption unit 120 is set according to the rule that has been described above with reference to FIG. 6. That is, in each area #k, the Tweak input to the first to (2\hat{ }b-2)th TBC functions is (N, a, i, 0, 0) for a block index i of the plaintext M. Note that the Tweak input to the last TBC function, i.e., the (2\hat{ }b-1)th TBC function, of the encryption unit 120 is (N, a, i, 1, 0). Note that in this example, since i is the index of the plaintext block number m, the Tweak input to each of the TBC functions in an area #k is different from the Tweak input to each of the TBC functions in another area. Note that when the number of the plaintext blocks is smaller than 2\hat{ }b-2 in the last area #β, the value of the random number Z_(j)\hat{ }(β) for which there is no plaintext block becomes zero. The same applies to the decryption processing performed by the authenticated decryption apparatus 20 (which will be described later).

The tag generation unit 140 generates an authentication tag T by a message authentication code (MAC; Message Authentication Code) using a Tweakable block cipher by using the set of random numbers S generated by the random number calculation unit 130 and a nonce N. To securely generate a tag T from the random numbers S, the tag generation unit 140 generates the tag T by unifying (or combining) the set of random numbers using a nonce-based MAC. Note that the nonce-based MAC is a MAC in which a nonce is included in an input of the MAC.

The tag generation unit 140 receives a nonce N from the nonce generation unit 104. Further, the tag generation unit 140 receives a set of random numbers from the random number calculation unit 130. As the random number calculation unit 130 performs the above-described processing for each area, the tag generation unit 140 obtains a set of random numbers as shown by the matrix shown in the below-shown Expression 8. Note that Expression 8 shows a random number matrix having a size ω×β in which the elements are random numbers S.

$$\begin{matrix}[ Expression 8 ] & \\ ( \begin{matrix}{S}_{1}^{( 1 )} & ⋯ & {S}_{1}^{( β )} \\ ⋮ & ⋱ & ⋮ \\ {S}_{ω}^{( 1 )} & ⋯ & {S}_{ω}^{( β )}\end{matrix} ) & ( 8 )\end{matrix}$$

Note that in the matrix shown in Expression 8, each column indicates random numbers S output for a corresponding area. That is, a kth column indicates w random numbers S_1\hat{ }(k), . . . , and S_ω\hat{ }(k) output to the tag generation unit 140 for an area #k. Note that since the data length of one random number S is b bits, the data length of the set of random numbers output for the area #k is ωb bits.

Further, in the matrix shown in Expression 8, each row indicates random numbers output in a corresponding line in the random number calculation unit 130. That is, an ith row indicates, for areas #1 to #β, β random numbers S_i\hat{ }(1), . . . , and S_i\hat{ }(β) output in a line i in the random number calculation unit 130. Note that the first row indicates, for the areas #1 to #β, random numbers S_1\hat{ }(1), . . . , and S_1\hat{ }(β) output from the encryption unit 120.

Then, the tag generation unit 140 generates a tag T[i] by processing the random numbers S_i\hat{ }(1), . . . , and S_i\hat{ }(β) included in each row of the random number matrix shown in Expression 8 by using a nonce-based MAC. In this way, as shown in below-shown Expression 9, the tag generation unit 140 generates tags T[1], . . . , and T[ω] by using the random number matrix shown in Expression 8.

$$\begin{matrix}[ Expression 9 ] & \\ ( \begin{matrix}{S}_{1}^{( 1 )} & ⋯ & {S}_{1}^{( β )} \\ ⋮ & ⋱ & ⋮ \\ {S}_{ω}^{( 1 )} & ⋯ & {S}_{ω}^{( β )}\end{matrix} ) \to ( \begin{matrix}T [ 1 ] \\ ⋮ \\ T [ ω ]\end{matrix} ) & ( 9 )\end{matrix}$$

Note that the tag generation unit 140 generates tags T[1], . . . , and T[ω] by using ω MACs (i.e., w pieces of MACs). That is, assuming that 1≤i≤w, the tag generation unit 140 generates a tag T[i] by using an ith MAC_i.

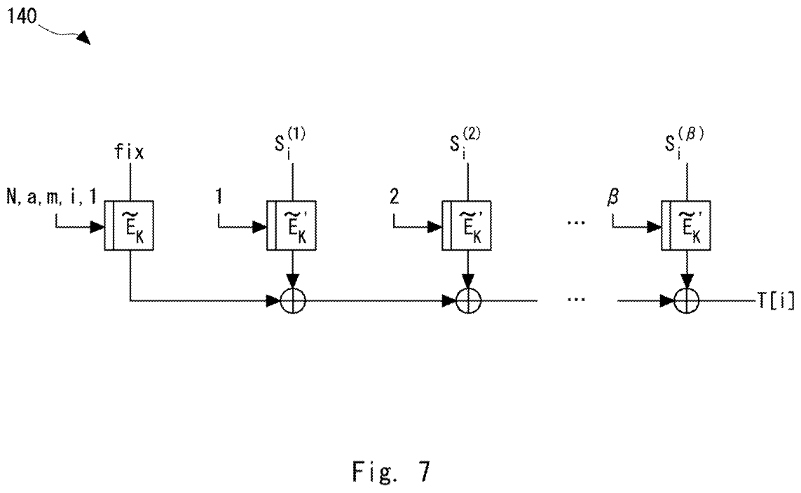

FIG. 7 shows an outline of calculation performed by the tag generation unit 140 according to the first example embodiment. FIG. 7 shows a tag deriving function used in the tag generation unit 140. That is, FIG. 7 shows a nonce-based MAC used in the tag generation unit 140. Note that FIG. 7 shows an example in which the tag generation unit 140 generates a tag T[i] by processing the random numbers S_i\hat{ }(1), . . . , and S_i\hat{ }(β) corresponding to an ith row in Expressions 8 and 9 by using a MAC_i.

The tag generation unit 140 encrypts a constant fix by a TBC function E_{K}^{˜} in which the key K, the nonce N, and the Tweak are input. Note that the Tweak input to the TBC function E_{K}^{˜} needs to be in the form shown in FIG. 7 for the security reason. That is, the tag generation unit 140 encrypts the constant fix by using the encryption result of the TBC function in which (N, a, m, i, 1) is input as a Tweak for an index i (1≤i≤ω) of each row (each line) in Expressions 8 and 9. Since the encryption result obtained by encrypting the constant fix is generated by using the TBC function in which the Tweak including the nonce is input, it can be regarded as a random number derived from the nonce.

Further, the tag generation unit 140 encrypts the random numbers S_i\hat{ }(1), . . . , and S_i\hat{ }(β) by the TBC function E_{K}^{˜}′. Note that the TBC function E_{K}^{˜}′ is a TBC function in which a Tweak different from any of the Tweaks input to the TBC functions E_{K}^{˜} shown in FIGS. 4 to 6 (and FIG. 7) is input. Note that the format of the Tweak input to the TBC function E_{K}^{˜}′ may be different from or the same as the format of the Tweak input to the TBC function E_{K}^{˜}. For example, the Tweak input to the TBC function E_{K}^{˜}′ for encrypting S_i\hat{ }(k) may be ((k)_n, a, m, i, 2). Note that “(k)_n” represents a numerical value k expressed as an n-bit value. Note that although the last value of this Tweak is “2”, the last value of the Tweaks input to the TBC functions E_{K}^{˜} shown in FIGS. 4 to 6 is not “2”. Therefore, it is possible to prevent the Tweak from coinciding with any of the other Tweaks.

Then, the tag generation unit 140 generates (i.e., calculates), as a tag T[i], an exclusive OR (sum total) of the encryption result obtained by encrypting the constant fix using the TBC function E_{K}^{˜} and the encryption results obtained by encrypting the random numbers S_i\hat{ }(1), . . . , and S_i\hat{ }(β) using the TBC function E_{K}^{˜}′. The tag generation unit 140 generates tags T[1], . . . , and T[ω] by performing the above-described processing for i=1 to ω. Then, the tag generation unit 140 outputs T[1], . . . , and T[ω] as a tag T=T[1]∥ . . . ∥T[ω].

Note that as described above, the nonce N is generated so that it does not coincide with any of its past values. Therefore, no nonce is used more than once to process a plaintext M. Therefore, it is possible to effectively achieve a desired level of security as compared to the MAC in which no nonce is included. That is, in order to achieve a desired security, for example, the MAC used for tag generation needs to be a MAC having b-bit security independent of the number of times of tagging queries. That is, a MAC that does not affect the security no matter how many times the MAC is called is desired. In other words, it is desired that the security of the MAC is not lowered no matter how many times an attacker carries out tagging queries.

Then, in the nonce-based MAC shown in FIG. 7, a random number derived from a nonce is output by the encryption of the constant fix. Note that as described above, the nonce N includes a different value for each authenticated encryption processing of a plaintext M. Therefore, in the encryption of the constant fix, a different random number can be output for each authenticated encryption processing of a plaintext M. Further, in the nonce-based MAC shown in FIG. 7, an exclusively OR of the sum total (exclusive OR) of the encryption results obtained by encrypting the random numbers S_i\hat{ }(1), . . . , and S_i\hat{ }(β) and the random number derived from the nonce is calculated. Therefore, the random numbers S_i\hat{ }(1), . . . , and S_i\hat{ }(β) and the sum total (exclusive OR) of their encryption results are masked. Therefore, for the attacker, a new random number is derived for each tagging query, so that the number times of tagging queries does not affect the security.

The output unit 150 performs control for outputting a ciphertext C and a tag T. Note that the output unit 150 may output a ciphertext C and a tag T while concatenating them. The output unit 150 may, for example, perform control so as to display the ciphertext C and the tag T on an output device such as a display. Further, the output unit 150 may, for example, perform control so as to output the ciphertext C and the tag T to an external apparatus connected thereto through a network. Further, the output unit 150 may perform control so as to output a nonce N and associated data A. For example, the output unit 150 transmits (N, A, C, T) to the authenticated decryption apparatus 20.

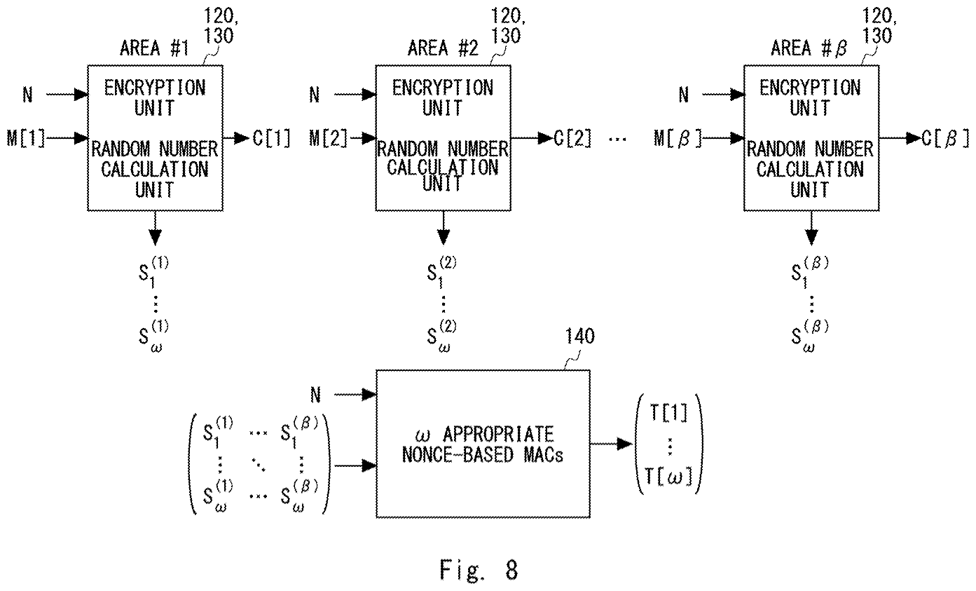

FIG. 8 is a diagram for explaining functions of the authenticated encryption apparatus 10 according to the first example embodiment. Note that in FIG. 8, the associated data is empty for the sake of clarifying the explanation. As described above, the authenticated encryption apparatus 10 groups (or divides) plaintext blocks of a plaintext M into area plaintext blocks M[1], M[2], . . . , and M[β] corresponding to an area #1, area #2, . . . , and area #β, respectively. Note that as described above, each of area plaintext blocks M[k] includes (2\hat{ }b-2) plaintext blocks.

Then, the encryption unit 120 and the random number calculation unit 130 generate, for the area #1, an area ciphertext block C[1] and a set of random numbers S_1\hat{ }(1), . . . , and S_ω\hat{ }(1) by using the input nonce N and the area plaintext block M[1]. Further, the encryption unit 120 and the random number calculation unit 130 generate, for the area #2, an area ciphertext block C[2] and a set of random numbers S_1\hat{ }(2), . . . , and S_ω\hat{ }(2) by using the input nonce N and the area plaintext block M[2]. After that, similarly, the encryption unit 120 and the random number calculation unit 130 generate, for each of the areas #k, an area ciphertext block C[k] and a set of random numbers S_1\hat{ }(k), . . . , and S_ω\hat{ }(k) by using the input nonce N and an area plaintext block M[k].

In this process, the encryption unit 120 can perform processing for each area by using calculation substantially the same as that in the encryption unit 84 according to the comparative example as a subroutine. Note that in this process, it is necessary to initialize (i.e., reset) the initial value for each area and appropriately set a Tweak. Further, the random number calculation unit 130 can perform processing, for each area, by calling the matrix AM shown in Expression 5 and using calculation substantially the same as that in the calculation unit 86 according to the comparative example as a subroutine. Note that it is necessary to initialize the initial value for each area. The same applies to the decryption processing performed by the authenticated decryption apparatus 20 (which will be described later).

Then, the tag generation unit 140 generates tags T[1], . . . , and T[ω] by using ω appropriate nonce-based MACs as described above by using the set of generated random numbers S (matrix shown in Expression 8) and the nonce N as inputs. Note that as described above, the set of encryption results of the generated random numbers S by the TBC functions is masked by random numbers derived from the nonces, so that the security of the generated set of random numbers S is ensured.

### <Authenticated Decryption Apparatus>

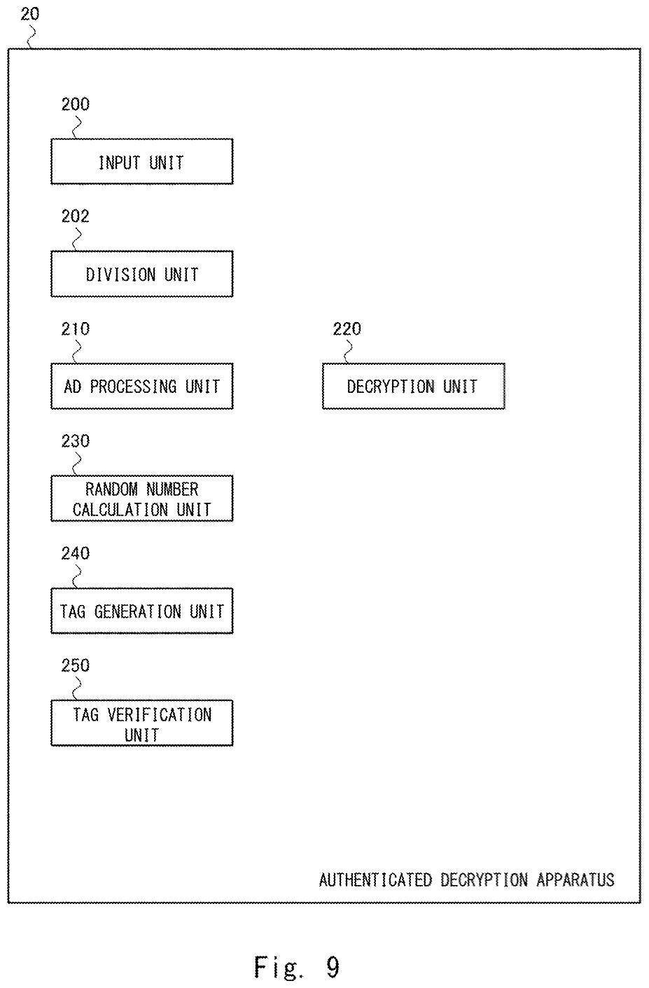

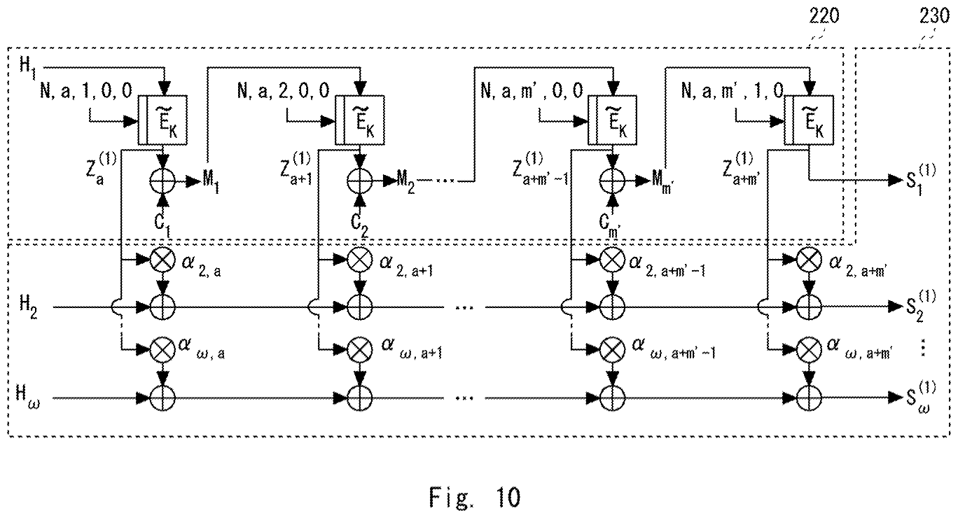

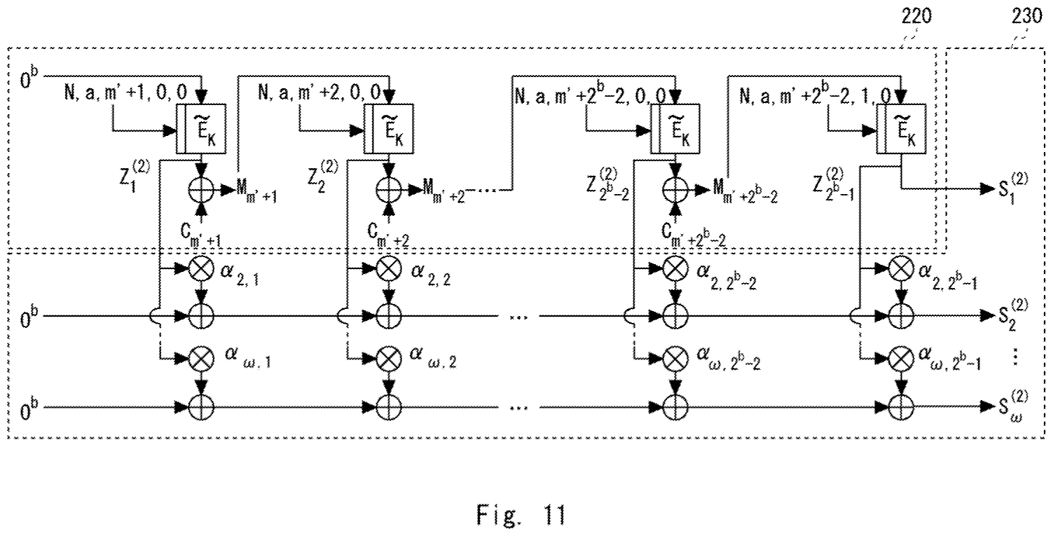

FIG. 9 shows a configuration of an authenticated decryption apparatus 20 according to the first example embodiment. Further, FIGS. 10 to 11 show an outline of calculation in authenticated decryption processing according to the first example embodiment. As shown in FIG. 9, the authenticated decryption apparatus 20 includes an input unit 200, a division unit 202, an AD processing unit 210, a decryption unit 220, a random number calculation unit 230, a tag generation unit 240, and a tag verification unit 250.

The authenticated decryption apparatus 20 can be implemented, for example, by an information processing apparatus such as a computer. That is, the authenticated decryption apparatus 20 includes a calculation apparatus such as a CPU and a storage device such as a memory or a disk. The authenticated decryption apparatus 20 implements each of the above-described components, for example, by having a calculation apparatus execute a program(s) stored in the storage device. This feature also applies to other example embodiments described later.

The input unit 200 functions as input means. The division unit 202 functions as dividing means. The AD processing unit 210 functions as associated data processing means. The decryption unit 220 functions as decryption means. The random number calculation unit 230 functions as random number calculation means (calculation means). The tag generation unit 240 functions as tag generation means. The tag verification unit 250 functions as tag verification means.

The input unit 200 receives an input of a nonce N, associated data A, a ciphertext C to be decrypted, and a tag T output from the authenticated encryption apparatus 10. The input unit 200 may be implemented, for example, by an input device such as a keyboard. The input unit 200 may receive an input of a nonce N, associated data A, a ciphertext C, and a tag T from, for example, an external apparatus connected thereto through a network. Note that in some cases, there is no associated data A, and in such cases, no associated data A is input. The input unit 200 outputs the nonce N to the decryption unit 220 and the tag generation unit 240. Further, the input unit 200 outputs the ciphertext C and the associated data A to the division unit 202. Further, the input unit 200 outputs the tag T to the tag verification unit 250.

The division unit 202 divides each of the ciphertext C and the associated data A into blocks each having a predetermined length. Specifically, the division unit 202 divides the ciphertext C into ciphertext blocks C_1, . . . , and C_m each having b bits. Note that m is the number of ciphertext blocks (i.e., the number of plaintext blocks). The division unit 202 outputs the ciphertext blocks C_1, . . . , and C_m to the decryption unit 220. The division unit 202 divides the associated data A into AD blocks A_1, . . . , and A_a each having a length of b bits. The division unit 202 outputs the AD blocks A_1, . . . , and A_a to the AD processing unit 210.

Further, similarly to the above-described division unit 102, the division unit 202 groups (or divides) the divided AD blocks A_1, . . . , and A_a and the divided ciphertext blocks C_1, . . . , and C_m into areas (groups) each containing (2\hat{ }b-2) blocks. That is, one area (i.e., segment) contains (2\hat{ }b-2) blocks. Note that the division unit 202 may group (i.e., divide) a data string D=A_1∥ . . . ∥A_a∥C_1∥ . . . ∥C_m into areas so that they are grouped, from the first block of the data string, in the order of an area #1, area #2, . . . , and area #β. Note that the grouping method may be the same as the above-described method in the division unit 102.

Note that when a bit string of ciphertext blocks grouped into an area #k is expressed as an “area ciphertext block C[k]”, the ciphertext C may also be expressed as C=C[1]∥C[2]∥ . . . ∥C[β]. Note that the number of ciphertext blocks included in each of area ciphertext blocks C[k] other than at least C[1] and C[β] becomes (2\hat{ }b-2). Further, when the associated data is empty, the number of ciphertext blocks included in the area ciphertext block C[1] also becomes (2\hat{ }b-2).

The AD processing unit 210 performs substantially the same processing as that performed by the above-described AD processing unit 110. That is, the AD processing unit 210 processes AD blocks A_1, . . . , and A_a by using the TBC function in which a key K and a Tweak are input. Note that the AD processing unit 210 processes the AD blocks on an area-by-area basis as described above. The AD processing unit 210 outputs H_1 to the decryption unit 220. Further, the AD processing unit 210 outputs random numbers Z_1, . . . , and Z_(a−1), which are the output values of the TBC functions, to the random number calculation unit 230. Note that the Tweak input to each of the TBC functions used in the AD processing unit 210 may be set substantially the same manner as the Tweak input to each of the TBC functions used in the above-described AD processing unit 110

The decryption unit 220 performs decryption processing corresponding to the above-described encryption processing performed by the encryption unit 120. The decryption unit 220 processes the ciphertext blocks C_1, . . . , and C_m by using the TBC function in which the key K and the Tweak are input. Note that the decryption unit 220 decrypts ciphertext blocks (ciphertext) on an area-by-area basis as described above. That is, the decryption unit 220 performs, for ciphertext blocks included in the area #1, decryption processing corresponding to the above-described encryption processing performed by the encryption unit 120. Then, the decryption unit 220 performs, for ciphertext blocks included in the area #2, decryption processing corresponding to the above-described encryption processing performed by the encryption unit 120. After that, the decryption unit 220 performs, for ciphertext blocks included in an area #k, decryption processing corresponding to the above-described encryption processing performed by the encryption unit 120. That is, the decryption unit 220 decrypts the area ciphertext blocks C[k] included in the area #k.

The decryption unit 220 outputs the generated plaintext blocks M_1, . . . , and M_m to the tag verification unit 250 as a plaintext M=M_1∥ . . . ∥M_m. Further, the decryption unit 220 obtains an area plaintext block M[k] by decrypting an area ciphertext block C[k] included in the area #k. Note that the decryption unit 220 may output the obtained plaintext to the tag verification unit 250 as a plaintext M=M[1]∥M[2]∥ . . . ∥M[β]. Further, the decryption unit 220 outputs a random number Z (output value of the TBC function) obtained in each area to the random number calculation unit 230. Further, the decryption unit 220 outputs an encryption result Z obtained by processing the last ciphertext block by the TBC function in each area to the tag generation unit 240 as a random number S_1. Details of the processing performed by the decryption unit 220 will be described later. Note that the Tweak input to each of the TBC functions used in the decryption unit 220 may be set substantially the same manner as the Tweak input to each of the TBC functions used in the above-described encryption unit 120.

Similarly to the above-described the random number calculation unit 130, the random number calculation unit 230 calculates random numbers S for generating a tag by using random numbers Z generated by the AD processing unit 210 and the decryption unit 220 and the predetermined matrix AM shown in Expression 5. Note that the random number calculation unit 230 calculates random numbers S for each area. Specifically, the random number calculation unit 230 generates, for each area, a set of ω-1 random numbers S (S_2, . . . , and S_ω) by using random numbers Z generated by the AD processing unit 210 and the decryption unit 220 and the predetermined matrix AM. Note that the set of random numbers S is used to generate a verification tag T*. Similarly to the above-described random number calculation unit 130, the random number calculation unit 230 calculates, in each area, S_i by calculating an exclusive OR of products of random numbers Z_j and α_(i, j) for each of the ω-1 lines i (2≤i≤ω). That is, the random number calculation unit 230 generates, in each area #k, a set of random numbers S_2\hat{ }(k), . . . , and S_ω\hat{ }(k) by processing the random numbers Z_1\hat{ }(k), . . . , and Z_(2\hat{ }b-1)\hat{ }(k) by using the matrix AM as shown in the above-shown Expression 6.

Note that the random number calculation unit 230 initializes (i.e., resets), for each area, the initial value of each line of the exclusive OR of products of Z and a. That is, the random number calculation unit 230 sets, for each area, the initial value of a line i to 0\hat{ }b. In other words, the random number calculation unit 230 initializes (i.e., resets), for each area, the initial value of each of a plurality of lines in which a set of random numbers is generated. Details of the processing performed by the random number calculation unit 230 will be described later. The random number calculation unit 230 outputs the set of random numbers S_1\hat{ }(k), . . . , and S_ω\hat{ }(k) generated for each area #k to the tag generation unit 240. Note that as described above, the random number S_1\hat{ }(k) in each area #k is generated by the decryption unit 220 and output to the tag generation unit 240.

FIG. 10 shows an outline of calculation performed by the decryption unit 220 and the random number calculation unit 230 for the first area, i.e., for the area #1. Note that since the calculation performed by the AD processing unit 210 for the area #1 is substantially the same as that shown in FIG. 4, it is not shown in the drawings. Further, FIG. 11 shows an outline of calculation performed by the decryption unit 220 and the random number calculation unit 230 for the second area, i.e., for the area #2.

As shown in FIG. 10, for the area #1, decryption processing is performed for ciphertext blocks C_1, . . . , and C_m′ among the ciphertext blocks C_1, . . . , and C_m. Specifically, the decryption unit 220 sets H_1 as the initial value. The decryption unit 220 encrypts the initial value H_1 by the TBC function E_{K}^{˜}. In this way, Z_a\hat{ }(1), which is a random number, is output from TBC function E_{K}^{˜} as the encryption result. Then, the decryption unit 220 obtains a plaintext block M_1 by an exclusive OR of this output encryption result Z_a and the first ciphertext block C_1.

Next, the decryption unit 220 encrypts the plaintext block M_1 by the TBC function E_{K}^{˜}. In this way, Z_(a+1)\hat{ }(1), which is a random number, is output as the encryption result. The decryption unit 220 obtains a plaintext block M_2 by an exclusive OR of the encryption result Z_(a+1)\hat{ }(1) and the second ciphertext block C_2. After that, the decryption unit 220 repeats the process of obtaining a plaintext block M_(i+1) by an exclusive OR of an encryption result Z_(a+i) of a plaintext block M_i decrypted by using a ciphertext block C_i and a ciphertext block C_(i+1).

Then, the decryption unit 220 obtains plaintext blocks M_1, . . . , and M_m′ corresponding to ciphertext blocks C_1, . . . , and C_m′, respectively. Further, the decryption unit 220 outputs the encryption results, i.e., the random numbers Z_a\hat{ }(1), . . . , and Z_(a+m′)\hat{ }(1), which are the output values of TBC functions, to the random number calculation unit 230. Note that the decryption unit 220 obtains the last random number Z_(atm′)\hat{ }(1) in the area #1 by encrypting the last plaintext block M_m′ in the area #1 by the last TBC function in the area #1. Further, when the last plaintext block M_m′ is encrypted by the TBC function, the decryption unit 220 outputs the encryption result Z_(a+m′)\hat{ }(1) to the random number calculation unit 230 as S_1\hat{ }(1).

Further, as shown in FIG. 10, the random number calculation unit 230 processes, for the area #1, Z_a\hat{ }(1), . . . , and Z_(a+m′)\hat{ }1 generated by the decryption unit 220. Note that although the AD processing unit 210 is not shown in FIG. 10, the random number calculation unit 230 processes, for the area #1, random numbers Z_1\hat{ }(1), . . . , and Z_(a−1)\hat{ }(1) generated by the AD processing unit 210 in a manner similar to that shown in FIG. 4. That is, according to the above-shown Expression 6, the random number calculation unit 230 processes random numbers Z_1\hat{ }(1), . . . , Z_(a−1)\hat{ }(1), Z_a\hat{ }(1), . . . , and Z_(a+m′)\hat{ }(1) by using the matrix AM shown in Expression 5. In this way, the random number calculation unit 230 generates a set of random numbers S_2\hat{ }(1), . . . , and S_ω\hat{ }(1) for the area #1. In other words, the random number calculation unit 230 generates a set of random numbers S_2\hat{ }(1), . . . , and S_ω\hat{ }(1) by calculating exclusive ORs of products of the random numbers Z_1\hat{ }(1), . . . , and Z_(a+m′) \hat{ }1 and the corresponding elements of the matrix AM. The random number calculation unit 230 outputs the set of random numbers S_1\hat{ }(1), . . . , and S_ω\hat{ }(1) generated for the area #1 to the tag generation unit 240.

Further, as shown in FIG. 11, the decryption unit 220 performs, for the area #2, processing similar to that performed for the area #1 for (2\hat{ }b-2) C_(m′+1), . . . , and C_(m′+2\hat{ }b-2), which follow C_m′, among the ciphertext blocks C_1, . . . , and C_m. Note that the decryption unit 220 initializes (i.e., resets), for the area #2, the initial value input to the first TBC function to 0\hat{ }b. Then, the decryption unit 220 obtains plaintext blocks M_(m′+1), . . . , and M_(m′+2\hat{ }b-2) corresponding to ciphertext blocks C_(m′+1), . . . , and C_(m′+2\hat{ }b-2), respectively. Further, the decryption unit 220 outputs the encryption result, i.e., the random numbers Z_1\hat{ }(2), . . . , and Z_(2\hat{ }b-1)\hat{ }(2), which are the output values of the TBC functions, to the random number calculation unit 230. Note that the decryption unit 220 obtains the last random number Z_(2\hat{ }b-1)\hat{ }(2) in the area #2 by encrypting the last plaintext block M_(m′+2\hat{ }b-2) in the area #2 by the last TBC function in the area #2. Further, when the last plaintext block M_(m′+2\hat{ }b-2) is encrypted by the TBC function, the decryption unit 220 outputs the encryption result Z_(2\hat{ }b-1)\hat{ }(2) to the random number calculation unit 230 as S_1\hat{ }(2).

Further, as shown in FIG. 11, the random number calculation unit 230 processes, for the area #2, the random numbers Z_1\hat{ }(2), . . . , and Z_(2\hat{ }b-1)\hat{ }(2) generated by the decryption unit 220 in substantially the same manner as that in the random number calculation unit 130. That is, according to the above-shown Expression 6, the random number calculation unit 230 processes random numbers Z_1\hat{ }(2), . . . , and Z_(2\hat{ }b-1)\hat{ }(2) by using the matrix AM shown in Expression 5. In this way, the random number calculation unit 230 generates a set of random numbers S_2\hat{ }(2), . . . , and S_ω\hat{ }(2) for the area #2. In other words, the random number calculation unit 230 generates a set of random numbers S_2\hat{ }(2), . . . , and S_ω\hat{ }(2) by calculating exclusive ORs of products of the random numbers Z_1\hat{ }(2), . . . , and Z_(2\hat{ }b-1)\hat{ }(2) and the corresponding elements of the matrix AM. Note that the random number calculation unit 230 initializes (i.e., resets), for the area #2, the initial value of each line i to 0\hat{ }b. The random number calculation unit 230 outputs the set of random numbers S_1\hat{ }(2), . . . , and S_ω\hat{ }(2) generated for the area #2 to the tag generation unit 240.

Note that although an outline of calculation for the areas #1 and #2 is shown in FIGS. 10 and 11, substantially the same calculation as that for the area #2 shown in FIG. 11 is performed for the area #3 and for the subsequent areas. Therefore, the description of specific processing for the area #3 and for the subsequent areas is omitted. Note that like the random number calculation unit 130, each time processing is performed for a given area, the random number calculation unit 230 repeatedly calls the same matrix AM (i.e., the same elements a) as that shown in Expression 5 and thereby generates a set of random numbers.

The tag generation unit 240 generates a verification tag T* by a message authentication code using a Tweakable block cipher by using the set of random numbers S generated by the random number calculation unit 230 and a nonce N. Note that the method for generating a tag T* is substantially the same as the method for generating a tag T in the tag generation unit 140. That is, the tag generation unit 240 generates (i.e., calculates), as a tag T*[i], an exclusive OR (sum total) of the encryption result obtained by encrypting the constant fix using the TBC function E_{K}^{˜} and the encryption results obtained by encrypting the random numbers S_i\hat{ }(1), . . . , and S_i\hat{ }(β) using the TBC function E_{K}^{˜}′. The tag generation unit 240 generates tags T*[1], . . . , and T*[ω] by performing the above-described processing for i=1 to ω. Then, the tag generation unit 240 outputs T*[1], . . . , and T*[ω] to the tag verification unit 250 as a tag T*=T*[1]∥ . . . ∥T*[ω].

The tag verification unit 250 verifies whether tampering has occurred by comparing the authentication tag T generated by the authenticated encryption apparatus 10 with the verification tag T* generated by the tag generation unit 240. Then, the tag verification unit 250 performs control so as to output information based on the verification result. Note that the tag verification unit 250 may perform control so as to display information, for example, on an output device such as a display. Further, the tag verification unit 250 may perform control so as to output information, for example, to an external apparatus connected thereto through a network.

Specifically, when the authentication tag T matches the verification tag T*, the tag verification unit 250 presumes (i.e., determines) that the authentication has succeeded and therefore performs control so as to output the plaintext M generated by the decryption unit 220. On the other hand, when the authentication tag T does not match the verification tag T*, the tag verification unit 250 presumes (i.e., determines) that the authentication has failed and therefore performs control so as to output an error message 1 indicating that the tag T does not match the tag T*.

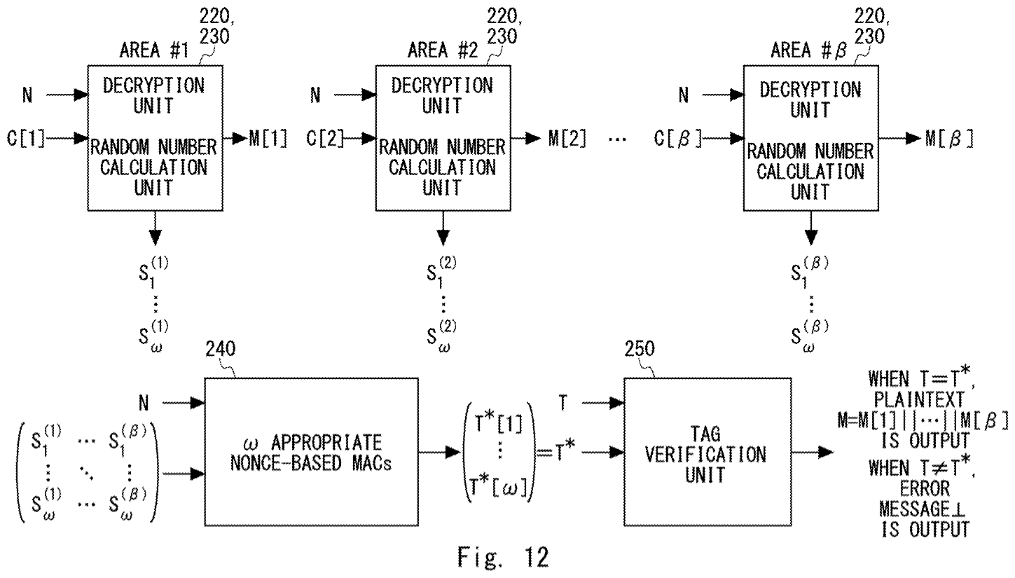

FIG. 12 is a diagram for explaining functions of the authenticated decryption apparatus 20 according to the first example embodiment. Note that in FIG. 12, for the sake of clarifying the explanation, the associated data is empty. As described above, the authenticated decryption apparatus 20 groups (or divides) the ciphertext blocks of the ciphertext C into area ciphertext blocks C[1], C[2], . . . , and C[β] corresponding to the area #1, area #2, . . . , and area #β, respectively. Note that as described above, each of the area ciphertext blocks C[k] includes (2\hat{ }b-2) ciphertext blocks.

Then, the decryption unit 220 and the random number calculation unit 230 generate, for the area #1, an area plaintext block M[1] and a set of random numbers S_1\hat{ }(1), . . . , and S_ω\hat{ }(1) by using the input nonce N and the area ciphertext block C[1]. Further, the decryption unit 220 and the random number calculation unit 230 generate, for the area #2, an area plaintext block M[2] and a set of random numbers S_1\hat{ }(2), . . . , and S_ω\hat{ }(2) by using the input nonce N and area ciphertext block C[2]. After that, similarly, the decryption unit 220 and the random number calculation unit 230 generate, for each of the areas #k, an area ciphertext block M[k] and a set of random numbers S_1\hat{ }(k), . . . , and S_ω\hat{ }(k) by using the input nonce N and the area plaintext block C[k].

Then, the tag generation unit 240 generates verification tags T*[1], . . . , and T*[ω] by using the generated set of random numbers S (matrix shown in Expression 8) and the nonce N as inputs, and by using ω appropriate nonce-based MACs as described above. Then, when the tag T matches the tag T*, the tag verification unit 250 outputs a plaintext M=M[1]∥ . . . ∥M[β]. On the other hand, when the tag T does not match the tag T*, the tag verification unit 250 outputs an error message 1.

### <Authenticated Encryption Method and Authenticated Decryption Method>

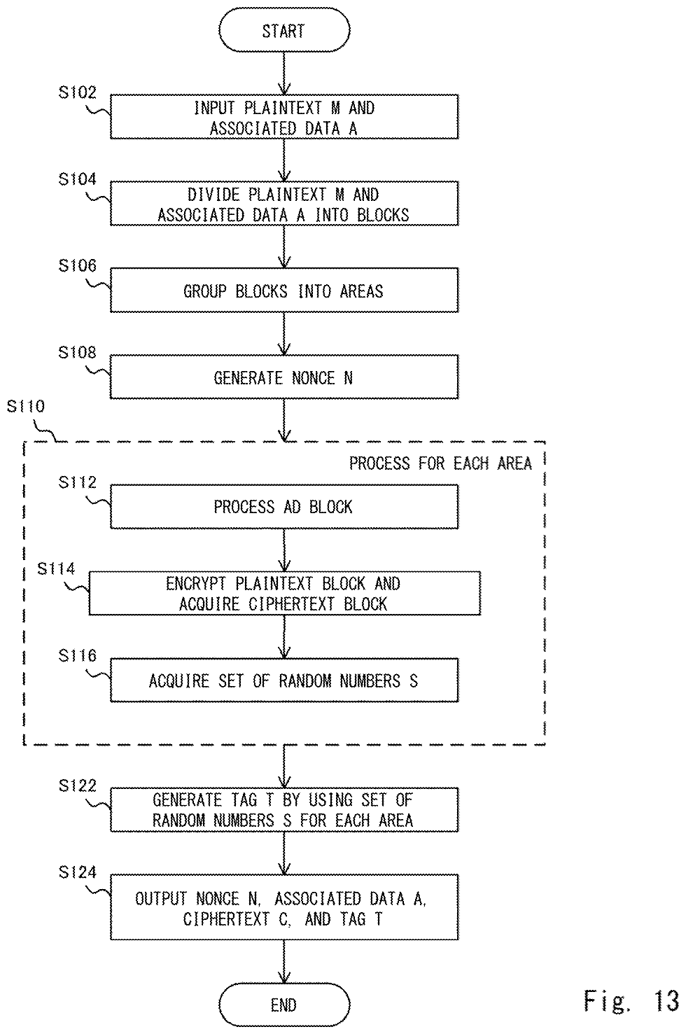

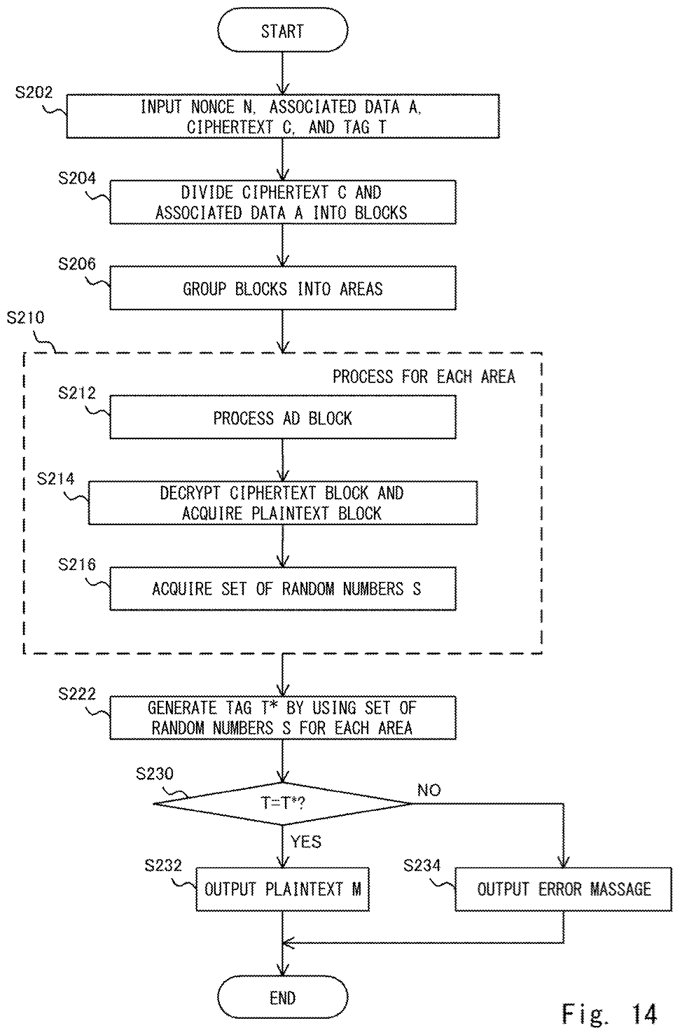

Next, operations performed by the authenticated encryption system 1 according to the first example embodiment will be described with reference to FIGS. 13 and 14. FIG. 13 is a flowchart showing an authenticated encryption method performed by the authenticated encryption apparatus 10 according to the first example embodiment.

As described above, the input unit 100 receives a plaintext M and associated data A (Step S102). As described above, the division unit 102 divides each of the plaintext M and the associated data A into blocks (plaintext blocks and AD blocks) each having a predetermined length (Step S104). Further, as described above, the division unit 102 groups (or divides) the divided AD blocks and plaintext blocks into respective areas (Step S106). The nonce generation unit 104 generates a nonce N as described above (Step S108).

Next, the AD processing unit 110, the encryption unit 120, and the random number calculation unit 130 perform processing for each area (Step S110). Specifically, the AD processing unit 110 processes the AD blocks as described above (Step S112). The encryption unit 120 encrypts the plaintext blocks and acquires ciphertext blocks as described above (Step S114). The random number calculation unit 130 acquires a set of random numbers S as described above (Step S116).

Next, as described above, the tag generation unit 140 generates a tag T by using the set of random numbers S generated for each area (Step S122). Then, the output unit 150 outputs the nonce N, the associated data A, the ciphertext C, and the tag T (Step S124).

FIG. 14 is a flowchart showing an authenticated decryption method performed by the authenticated decryption apparatus 20 according to the first example embodiment. The input unit 200 receives a nonce N, associated data A, a ciphertext C, and a tag T (Step S202). As described above, the division unit 202 divides each of the ciphertext C and the associated data A into blocks (ciphertext blocks and AD blocks) each having a predetermined length (Step S204). Further, as described above, the division unit 202 groups (or divides) the divided AD blocks and the ciphertext blocks into respective areas (Step S206).

Next, the AD processing unit 210, the decryption unit 220, and the random number calculation unit 230 perform processing for each area (Step S210). Specifically, the AD processing unit 210 processes the AD blocks as described above (Step S212). The decryption unit 220 decodes the ciphertext blocks and acquires plaintext blocks as described above (Step S214). The random number calculation unit 230 acquires the set of random numbers S as described above (Step S216).

Next, as described above, the tag generation unit 240 generates a tag T* by using the set of random numbers S generated for each area (Step S222). As described above, the tag verification unit 250 determines whether or not the authentication tag T matches the verification tag T* (Step S230). When the authentication tag T matches the verification tag T* (Yes in step S230), the tag verification unit 250 outputs a plaintext M (Step S232). On the other hand, when the authentication tag T does not match the verification tag T* (No in step S230), the tag verification unit 250 outputs an error message 1 (Step S234).

### <Effects>

As described above, the authenticated encryption apparatus 10 according to the first example embodiment groups (i.e., divides) input blocks (AD blocks and plaintext blocks) into areas each containing (2\hat{ }b-2) blocks, i.e., each having a size that can be processed by the PFBω method according to the comparative example. Further, the authenticated encryption apparatus 10 according to the first example embodiment is configured to appropriately derive a tag T from a set of random numbers S generated in each area. In this way, the authenticated encryption system 1 according to the first example embodiment can process (2\hat{ }b-1) input blocks or more, which cannot be handled in the PFBω method according to the comparative example due to the security reason.

Further, as described above, although the security of ωb bits can be achieved in the comparative example, the limit on the number of input blocks is the same as that in the AE in which the security is b bits. Therefore, in the comparative example, in order to transmit a plaintext having a size exceeding the limit on the number of input blocks (a size exceeding b×(2\hat{ }b-2) bits), it is necessary to divide the plaintext into a plurality of blocks each having a processible size in advance. Further, it is necessary to encrypt each of divided plaintexts and then transmit obtained ciphertexts. That is, in the comparison example, it is necessary to transmit a plurality of items (N, A, C, T) for each plaintext. In contrast, in the authenticated encryption system 1 according to the first example embodiment, since there is no limit on the number of blocks that can be processed, it is possible to transmit a ciphertext all at once irrespective of the size of the plaintext. That is, in the first example embodiment, only one set of items (N, A, C, T) needs to be transmitted. Therefore, the communication load can be reduced.

### Second Example Embodiment

Next, a second example embodiment will be described. For the sake of clarifying the explanation, the following descriptions and drawings are omitted and simplified as appropriate. Further, the same elements are assigned the same reference numerals (or symbols) throughout the drawings, and redundant descriptions are omitted as appropriate. Note that since a configuration of a system according to the second example embodiment is substantially the same as that according to the first example embodiment, the description thereof will be omitted. That is, an authenticated encryption system 1 according to the second example embodiment includes an authenticated encryption apparatus 10A corresponding to the authenticated encryption apparatus 10 and an authenticated decryption apparatus 20A corresponding to the authenticated decryption apparatus 20.

The second example embodiment corresponds to a ΘCBω method which is an improved version of the above-described PFBω method according to the comparative example, and is extended to a ΘCB method mentioned in the comparative example. That is, in the second example embodiment, processing (encryption or decryption, and AD processing) of blocks using the TBC function in the PFBω can be performed in parallel. Further, in the second example embodiment, like the first example embodiment, plaintext blocks (and AD blocks) are grouped (or divided) into areas each having a predetermined length, and processing is performed for each area.

### <Authenticated Encryption Apparatus>

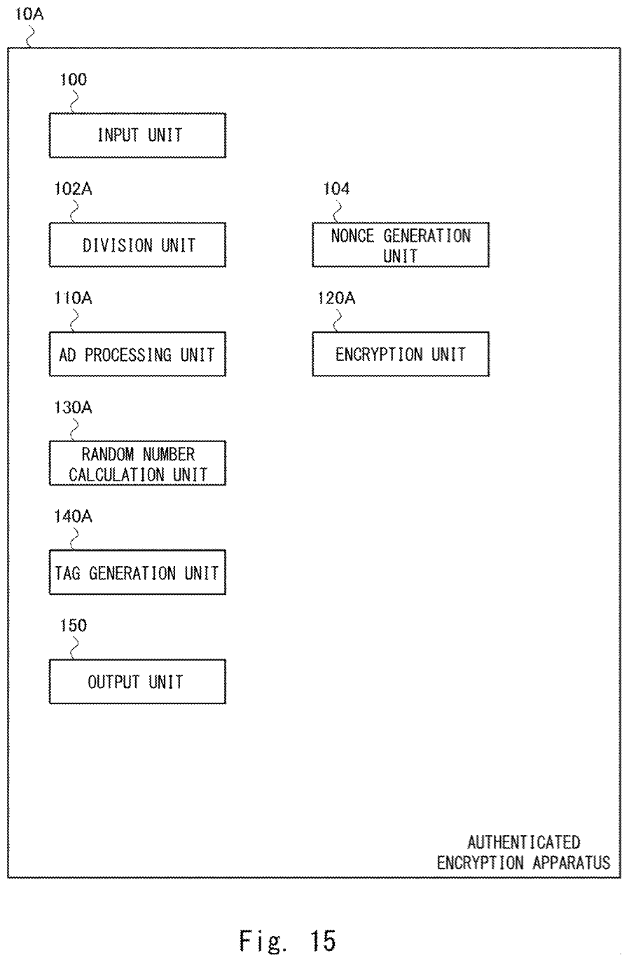

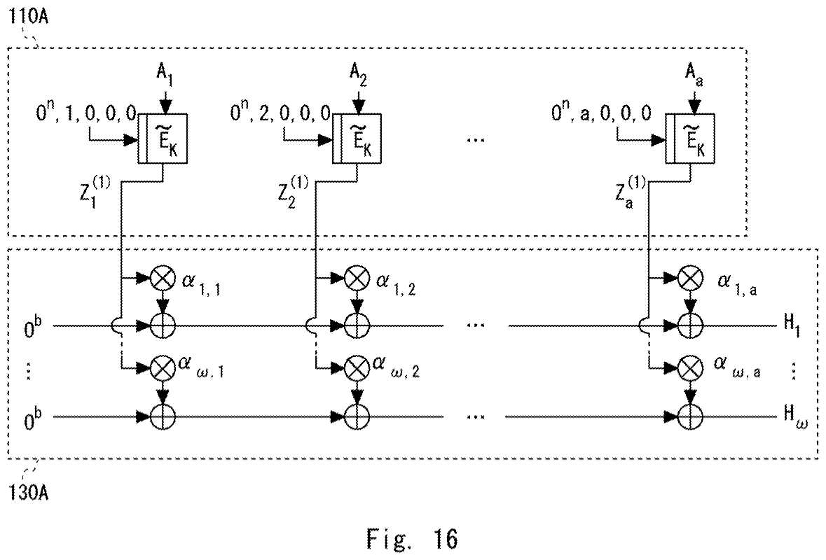

FIG. 15 shows a configuration of an authenticated encryption apparatus 10A according to the second example embodiment. FIGS. 16 to 18 show an outline of calculation in authenticated encryption processing according to the second example embodiment. As shown in FIG. 15, the authenticated encryption apparatus 10A includes an input unit 100, a division unit 102A, a nonce generation unit 104, an AD processing unit 110A, an encryption unit 120A, a random number calculation unit 130A, a tag generation unit 140A, and an output unit 150.

The authenticated encryption apparatus 10A corresponds to the authenticated encryption apparatus 10 shown in FIGS. 2 and 3. The division unit 102A corresponds to the division unit 102 according to the first example embodiment. The AD processing unit 110A corresponds to the AD processing unit 110 according to the first example embodiment. The encryption unit 120A corresponds to the encryption unit 120 according to the first example embodiment. The random number calculation unit 130A corresponds to the random number calculation unit 130 according to the first example embodiment. The tag generation unit 140A corresponds to the tag generation unit 140 according to the first example embodiment. Note that the configuration of the authenticated encryption apparatus 10A will be described with a particular emphasis on parts thereof that are different from those of the authenticated encryption apparatus 10.

Similarly to the division unit 102 according to the first example embodiment, the division unit 102A divides each of a plaintext M and associated data A into blocks each having a predetermined length. Specifically, the division unit 102A divides the plaintext M into b-bit plaintext blocks M_1, . . . , and M_m. The division unit 102A outputs the plaintext blocks M_1, . . . , and M_m to the encryption unit 120A. Further, the division unit 102A divides the associated data A into AD blocks A_1, . . . , and A_a each having a length of b bits. The division unit 102A outputs the AD blocks A_1, . . . , and A_a to the AD processing unit 110A.

Further, the division unit 102A groups (or divides) the divided AD blocks A_1, . . . , and A_a and the divided plaintext blocks M_1, . . . , and M_m into areas (groups) each of which contains (2\hat{ }b-1) blocks. That is, in the second example embodiment, one area contains (2\hat{ }b-1) blocks. Note that the division unit 102A groups a data string D=A_1∥ . . . ∥A_a∥M_1∥ . . . ∥M_m into areas so that they are grouped, from the first block of the data string, in the order of an area #1, area #2, . . . , and area #β. Note that unlike the first example embodiment, the reason why the number of blocks contained in one area is (2\hat{ }b-1) in the second example embodiment is that parallel processing of blocks can be performed in the second example embodiment. Its details will be described later.

The division unit 102A groups the blocks (i.e., performs the segmentation of the blocks) so that all the AD blocks A_1, . . . , and A_a are included in the area #1. Further, in the case of a<2\hat{ }b-1, the division unit 102A groups the blocks (i.e., performs the segmentation of the blocks) so that m′ plaintext blocks are included in the area #1. Note that m′ is the number of plaintext blocks included in the area #1 (first area). Further, m′ satisfies a relation “a+m′=2\hat{ }b-1”. Further, the division unit 102A groups the remaining (m-m′) plaintext blocks into the areas #2 to #β. The following description will be given on the assumption that a relation “a<2\hat{ }b-1” holds, unless otherwise specified. Note that processing that is performed under the condition that a=2\hat{ }b-1 or a>2\hat{ }b-1 is substantially the same as processing performed under the condition a=2\hat{ }b-2 or a>2\hat{ }b-2 in the first example embodiment.

Note that when the associated data is empty, the division unit 102A groups the data string D=M_1∥ . . . ∥M_m into areas so that they are grouped, from the first block of the data string, in the order of an area #1, area #2, . . . , and area #β. Note that when the number of the plaintext blocks grouped into the area #1 is represented by m′, a relation “m′=2\hat{ }b-1” holds.

Note that when the bit string of plaintext blocks grouped into an area #k is expressed as an “area plaintext block M[k]”, the plaintext M can also be expressed as M=M[1]∥M[2]∥ . . . ∥M[β]. Then, the number of plaintext blocks included in each of area plaintext blocks M[k] other than at least M[1] and M[β] becomes (2\hat{ }b-1). Further, when the associated data is empty, the number of plaintext blocks included in the area plaintext block M[1] also becomes (2\hat{ }b-1).

The AD processing unit 110 processes the associated data A in a manner similar to that in the AD processing unit 110A according to the first example embodiment. Note that the AD processing unit 110A processes the AD blocks A_1, . . . , and A_a in parallel with each other by using the TBC function in which a key K and a Tweak are input. In this process, the AD processing unit 110A processes the AD blocks on an area-by-area basis as described above. The AD processing unit 110A obtains random numbers Z by inputting each of AD blocks into the TBC function in which the key K and the Tweak are input. The AD processing unit 110A outputs intermediate values Z_1, . . . , and Z_a, which are the output values (random numbers) of respective TBC functions, to the random number calculation unit 130A. Details of processing performed by the AD processing unit 110A will be described later.

The encryption unit 120A processes the plaintext M in a manner similar to that in the encryption unit 120 according to the first example embodiment. Note that the encryption unit 120A processes the plaintext blocks M_1, . . . , and M_m in parallel with each other by using the TBC function in which the key K and the Tweak are input. In this process, the encryption unit 120A encrypts the plaintext blocks (plaintext) in parallel with each other by using the TBC function on an area-by-area basis as described above. That is, the encryption unit 120A encrypts plaintext blocks included in the area #1 in parallel with each other by using the TBC function. Further, the encryption unit 120A encrypts plaintext blocks included in the area #2 in parallel with each other by using the TBC function. After that, the encryption unit 120A encrypts plaintext blocks included in an area #k in parallel with each other by using the TBC function. That is, the encryption unit 120A encrypts, for area plaintext blocks M[k] included in the area #k, plaintext blocks in parallel with each other. The encryption unit 120A inputs each of the plaintext blocks into the TBC function in which the key K and the Tweak are input, and thereby obtains ciphertext blocks as the output values of the TBC functions. That is, the encryption unit 120A generates, for each area, ciphertext blocks by encrypting a plurality of plaintext blocks in parallel with each other by using the TBC function.

The encryption unit 120A outputs the generated ciphertext blocks C_1, . . . , and C_m to the output unit 150 as a ciphertext C=C_1∥ . . . ∥C_m. Further, the encryption unit 120A obtains an area ciphertext block C[k] by encrypting an area plaintext block M[k] included in an area #k. Note that the area ciphertext block C[k] consists of the same number of ciphertext blocks as the number of plaintext blocks of the area plaintext block M[k]. Further, the encryption unit 120A outputs plaintext blocks (input values of the TBC function), which will be input to the TBC functions in respective areas, to the random number calculation unit 130A as intermediate values Z. Details of the processing of the encryption unit 120A will be described later.

Note that the Tweak input to each of the TBC functions used in the encryption unit 120A may be different from the Tweak input to each of the TBC functions used in the encryption unit 84. Its details will be described later. Note that similarly to the first example embodiment, in order to distinguish Tweaks input to TBC functions used in the AD processing, the encryption processing and the like, which are performed on an area-by-area basis, from each other, the number of digits of a Tweak in the second example embodiment is larger than the number of digits of a Tweak in the comparative example. That is, while processing is performed in only one area in the comparative example, processing is performed for a plurality of areas in the second example embodiment, so that it is necessary to increase the number of digits of Tweaks in order to distinguish Tweaks from each other.

Similarly to the random number calculation unit 130 according to the first example embodiment, the random number calculation unit 130A calculates random numbers for generating a tag. The random number calculation unit 130A calculates values for generating a tag by using the random numbers (intermediate values) Z generated by the AD processing unit 110A, the plaintext blocks output from the encryption unit 120A, and a predetermined matrix AM. Note that the matrix AM according to the second example embodiment is shown in the below-shown Expression 10. Note that the matrix AM is a matrix having a size ω×(2\hat{ }b-1) in which the elements are predetermined values α_(i, j).

$$\begin{matrix}[ Expression 10 ] & \\ AM = ( \begin{matrix}{α}_{1 , 1} & ⋯ & {α}_{1 , {2}^{b} - 1} \\ ⋮ & ⋱ & ⋮ \\ {α}_{ω , 1} & ⋯ & {α}_{ω , {2}^{b} - 1}\end{matrix} ) & ( 10 )\end{matrix}$$

The random number calculation unit 130A calculates random numbers S for each area. The random number calculation unit 130A generates a set of random numbers S for each area by performing substantially the same processing as that performed by the random number calculation unit 130. Specifically, the random number calculation unit 130A generates, for each area, a set of w random numbers S (S_1, . . . , and S_ω) by using random numbers (intermediate values) Z generated by the AD processing unit 110A, plaintext blocks (intermediate values Z) output from the encryption unit 120A, and a predetermined matrix AM. Note that the set of random numbers S is used to generate a tag T. The random number calculation unit 130A calculates, for each area, S_i by calculating an exclusive OR of products of the intermediate values Z_j and α_(i, j) for each of ω lines i (1≤i≤ω). Its details will be described later.

The random number calculation unit 130A generates, for each area #k, a set of random numbers S_1\hat{ }(k), . . . , and S_ω\hat{ }(k) by processing intermediate values Z_1\hat{ }(k), . . . , and Z_(2\hat{ }b-1)\hat{ }(k) by using the matrix AM as shown in the below-shown Expression 11. That is, the random number calculation unit 130A generates, for each area #k, a set of random numbers by using the same matrix AM as that shown in Expression 10.

$$\begin{matrix}[ Expression 11 ] & \\ ( \begin{matrix}{α}_{1 , 1} & ⋯ & {α}_{1 , {2}^{b} - 1} \\ ⋮ & ⋱ & ⋮ \\ {α}_{ω , 1} & ⋯ & {α}_{ω , {2}^{b} - 1}\end{matrix} ) ( \begin{matrix}{Z}_{1}^{( k )} \\ ⋮ \\ {Z}_{{2}^{b} - 1}^{( k )}\end{matrix} ) = ( \begin{matrix}{S}_{1}^{( k )} \\ ⋮ \\ {S}_{ω}^{( k )}\end{matrix} ) & ( 11 )\end{matrix}$$

Note that based on Expression (11), the below-shown Expression 12 holds for i (1≤i≤ω).

$$\begin{matrix}[ Expression 12 ] & \\ {S}_{i}^{( k )} = {α}_{i , 1} \cdot {Z}_{1}^{( k )} ⊕ {α}_{i , 2} \cdot {Z}_{2}^{( k )} ⊕ … ⊕ {α}_{i , {2}^{b} - 1} \cdot {Z}_{{2}^{b} - 1}^{( k )} & ( 12 )\end{matrix}$$

Note that similarly to the random number calculation unit 130, the random number calculation unit 130A initializes (i.e., resets), for each area, the initial value of each line of the exclusive OR of products of Z and a. That is, the random number calculation unit 130A sets the initial value of a line i to 0\hat{ }b for each area. In other words, the random number calculation unit 130A initializes (i.e., resets), for each area, the initial value of each of a plurality of lines in which a set of random numbers is generated. Details of the processing performed by the random number calculation unit 130A will be described later. The random number calculation unit 130A outputs the set of random numbers S_1\hat{ }(k), . . . , and S_ω\hat{ }(k) generated for each area #k to the tag generation unit 140A.

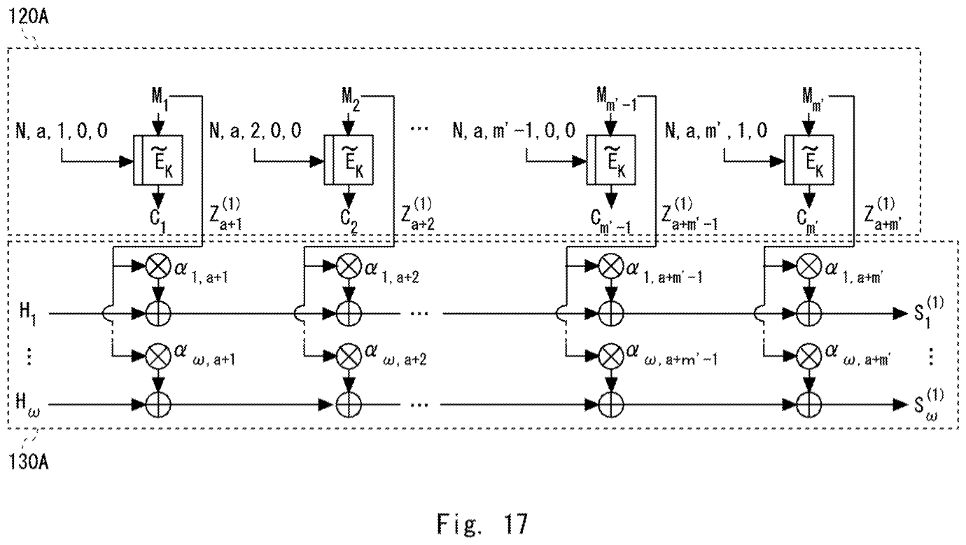

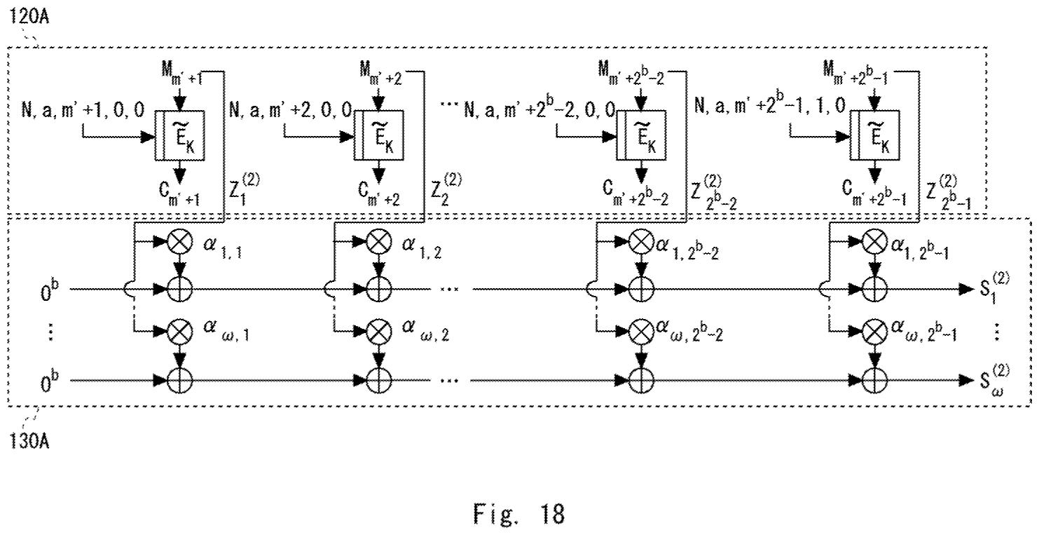

FIG. 16 shows an outline of calculation performed by the AD processing unit 110A and the random number calculation unit 130A for the first area, i.e., for the area #1. Further, FIG. 17 shows an outline of calculation performed by the encryption unit 120A and the random number calculation unit 130A for the first area, i.e., for the area #1. Further, FIG. 18 shows an outline of calculation performed by the encryption unit 120A and the random number calculation unit 130A for the second area, i.e., for the area #2.

As shown in FIG. 16, the AD processing unit 110A processes, for the area #1, AD blocks A_1, . . . , and A_a in parallel with each other by using the TBC function in which a key K and a Tweak are input. Specifically, the AD processing unit 110A encrypts the AD block A_1 by the TBC function. As a result, Z_1\hat{ }(1), which is an intermediate value (random number), is output from the TBC function as an encryption result. Similarly, the AD processing unit 110A encrypts the AD block A_2 by the TBC function. As a result, Z_2\hat{ }(1), which is an intermediate value (random number), is output from the TBC function as an encryption result. Similarly, the AD processing unit 110A encrypts an AD block A_a by the TBC function. As a result, Z_a\hat{ }(1), which is an intermediate value (random number), is output from the TBC function as an encryption result. The AD processing unit 110A outputs the encryption results, i.e., intermediate values Z_1\hat{ }(1), . . . , and Z_a\hat{ }(1), which are the output values of the TBC function, to the random number calculation unit 130A.

Note that in the first example embodiment, the number of random numbers Z, which are output values from the TBC functions, is smaller than the number of AD blocks by one. In contrast, in the second example embodiment, since the AD blocks can be processed in parallel with each other, the number of intermediate values Z, which are output values from the TBC functions, is equal to the number of AD blocks. Note that in the examples shown in FIGS. 16 to 18, since the relation “a<2\hat{ }b-(1)” holds, the AD processing unit 110A performs processing only for the area #1.

Further, as shown in FIG. 17, for the area #1, the encryption unit 120A encrypts, among plaintext blocks M_1, . . . , and M_m, plaintext blocks M_1, . . . , and M_m′ in parallel with each other by using the TBC functions in which the key K and Tweaks are input. Specifically, the encryption unit 120A encrypts the plaintext block M_1 by the TBC function. As a result, a ciphertext block C_1 is output from the TBC function as an encryption result. Similarly, the encryption unit 120A encrypts the plaintext block M_2 by the TBC function. As a result, a ciphertext block C_2 is output from the TBC function as an encryption result. Similarly, the encryption unit 120A encrypts a plaintext block M_m′ by the TBC function. As a result, a ciphertext block C_m′ is output from the TBC function as an encryption result. In this way, the encryption unit 120A obtains ciphertext blocks C_1, . . . , and C_m′ corresponding to the plaintext blocks M_1, . . . , and M_m′, respectively. Further, the encryption unit 120A outputs the plaintext blocks M_1, . . . , and M_m′, which are the inputs to the TBC functions, to the random number calculation unit 130A as intermediate values Z_(a+1)\hat{ }(1), . . . , and Z_(a+m′) \hat{ }(1), respectively.

Note that the Tweak input to each of the TBC functions used in the AD processing unit 110A and the encryption unit 120A may be set according to substantially the same rule as that in the AD processing unit 110 and the encryption unit 120. That is, the Tweak input to the TBC function used in the AD processing unit 110A is (0\hat{ }n, i, 0, 0, 0) for a block index i (1≤i≤a) of the associated data A. Further, the Tweak input to the TBC function used in the encryption unit 120A is (N, a, i, 0, 0) for a block index i (1≤i≤m′) of the plaintext M. Note that for the area #1, the Tweak input to the TBC function used in the last process performed by the encryption unit 120A is (N, a, m′, 1, 0). That is, regarding the Tweak input to the TBC function used in the last process for the area, x in (N, a, i, x, 0) is set to “1”. By setting the Tweak as described above, no Tweak coincides with any of the other Tweaks.

Further, as shown in FIGS. 16 and 17, the random number calculation unit 130A processes, for the area #1, intermediate values Z_1\hat{ }(1), . . . , Z_a\hat{ }(1), Z_(a+1)\hat{ }(1), . . . , and Z_(a+m′) \hat{ }(1) output from the AD processing unit 110A and the encryption unit 120A. That is, based on the above-shown Expression 11, the random number calculation unit 130A processes the intermediate value Z_1\hat{ }(1), . . . , Z_a\hat{ }(1), Z_(a+1)\hat{ }(1), . . . , and Z_(a+m′) \hat{ }(1) by using the matrix AM shown in Expression 10. In this way, the random number calculation unit 130A generates a set of random numbers S_1\hat{ }(1), . . . , and S_ω\hat{ }(1) for the area #1. The random number calculation unit 130A outputs the set of random numbers S_1\hat{ }(1), . . . , and S_ω\hat{ }(1) generated for the area #1 to the tag generation unit 140A.

Further, as shown in FIG. 18, the encryption unit 120A performs, for the area #2, processing similar to that for the area #1 for (2\hat{ }b-1) M_(m′+1), . . . , and M_(m′+2\hat{ }b-1), which follow M_m′, among the plaintext blocks M_1, . . . , and M_m. That is, the encryption unit 120A, for the area #2, encrypts plaintext blocks M_(m′+1), . . . , and M_(m′+2\hat{ }b-1) in parallel with each other by using the TBC functions in which the key K and Tweaks are input. In this way, the encryption unit 120A obtains ciphertext blocks C_(m′+1), . . . , and C_(m′+2\hat{ }b-1) corresponding to the plaintext blocks M_(m′+1), . . . , and M_(m′+2\hat{ }b-1), respectively. Further, the encryption unit 120A outputs the plaintext blocks M_(m′+1), . . . , and M_(m′+2\hat{ }b-1), which are the inputs to the TBC functions, to the random number calculation unit 130A as intermediate values Z_1\hat{ }(2), . . . , and Z_(2\hat{ }b-1)\hat{ }(2), respectively.

Further, as shown in FIG. 18, the random number calculation unit 130A processes, for the area #2, the intermediate values Z_1\hat{ }(2), . . . , and Z_(2\hat{ }b-1)\hat{ }(2), corresponding to the plaintext blocks, output from the encryption unit 120A. That is, based on the above-shown Expression 11, the random number calculation unit 130A processes the intermediate value Z_1\hat{ }(2), . . . , and Z_(2\hat{ }b-1)\hat{ }(2) by using the matrix AM shown in Expression 10. In this way, the random number calculation unit 130A generates a set of random numbers S_1\hat{ }(2), . . . , and S_ω\hat{ }(2) for the area #2. Note that similarly to the random number calculation unit 130, the random number calculation unit 130A initializes (i.e., resets), for the area #2, the initial value of each line i to 0\hat{ }b. The random number calculation unit 130A outputs the set of random numbers S_1\hat{ }(2), . . . , and S_ω\hat{ }(2) generated for the area #2 to the tag generation unit 140A.

Note that for the area #2, the Tweak input to each of the TBC functions used in the encryption unit 120A may be set according to substantially the same rule as that in the encryption unit 120. That is, the Tweak input to the TBC function used in the encryption unit 120A is (N, a, i, 0, 0) for a block index i (m′+1≤i≤m′+2\hat{ }b-1) of the plaintext M. Note that for the area #2, the Tweak input to the TBC function used at the last process performed by the encryption unit 120A is (N, a, m′+2\hat{ }b-1, 1, 0). That is, regarding the Tweak input to the TBC function used in the last process for the area, x in (N, a, i, x, 0) is set to “1”. By setting the Tweak as described above, no Tweak coincides with any of the other Tweaks.

Note that as described above in the problem in the comparison example, the number of columns of the matrix AM must not exceed 2\hat{ }b-1. Therefore, similarly to the first example embodiment, the number of columns of the matrix AM is (2\hat{ }b-1) as shown in Expression 10 in the second example embodiment. Note that blocks are encrypted in parallel with each other in the authenticated encryption according to the second example embodiment. Therefore, in the second example embodiment, as shown in FIG. 16, all that has to be done to process a AD blocks (i.e., “a” pieces of AD blocks) is to prepare a matrix AM of which the number of columns is a. Further, in the second example embodiment, as shown in FIGS. 17 and 18, all that has to be done to process m″ plaintext blocks is to prepare a matrix AM of which the number of columns is m″. That is, in the second example embodiment, the number of blocks to be processed is equal to the number of columns of the corresponding matrix AM. Therefore, in order to satisfy the condition for the matrix AM described above in the problem in the comparison example, it is sufficient if a relation “a+m”≤2\hat{ }b-1″ holds. Therefore, in the second example embodiment, the number of blocks (AD blocks or plaintext blocks) included in one area is set to (2\hat{ }b-1). Further, for the area #1, the relation “a+m′=2\hat{ }b-1” holds. Therefore, the number of blocks that can be processed in one area in the second example embodiment may be larger than the number of blocks that can be processed in one area in the first example embodiment by one. Note that since the relation “a+m′=2\hat{ }b-1” holds, α_(1, a+m′+1) in FIG. 17 corresponds to α_(1, 2\hat{ }b-1) in Expression 10.

Note that although an outline of calculation for the areas #1 and #2 is shown in FIGS. 16 to 18, substantially the same calculation as that for the area #2 shown in FIG. 18 is performed for the area #3 and for the subsequent areas. Therefore, the description of specific processing for the area #3 and for the subsequent areas is omitted. Note that each time processing is performed for a given area, the random number calculation unit 130A initializes (i.e., resets) the initial value of each line, repeatedly calls the same matrix AM (i.e., the same elements a) as that shown in Expression 10, and thereby generates a set of random numbers.

Note that the Tweak input to each of the TBC functions used in the encryption unit 120A is set according to the rule that has been described above with reference to FIG. 18. That is, in each area #k, the Tweak input to the first to (2\hat{ }b-2)th TBC functions is (N, a, i, 0, 0) for a block index i of the plaintext M. Further, in each area #k, the Tweak input to the (2\hat{ }b-1)th TBC function is (N, a, i, 1, 0) for a block index i of the plaintext M. Note that in this example, since i is the index of the plaintext block number m, the Tweak input to each of the TBC functions in an area #k is different from the Tweak input to each of the TBC functions in another area. Note that when the number of the plaintext blocks is smaller than 2\hat{ }b-1 in the last area #β, the value of the intermediate value Z_(j)\hat{ }(β) for which there is no plaintext block becomes zero. The same applies to the decryption processing performed by the authenticated decryption apparatus 20A (which will be described later).

Similarly to the tag generation unit 140 according to the first example embodiment, the tag generation unit 140A generates a tag. The tag generation unit 140A generates, by using the set of random numbers S generated by the random number calculation unit 130A and the nonce N, an authentication tag T by a message authentication code using a Tweakable block cipher. Note that the processing performed by the tag generation unit 140A is substantially the same as that performed by the tag generation unit 140 according to the first example embodiment. That is, as the random number calculation unit 130A performs the above-described processing for each area, the tag generation unit 140A obtains a set of random numbers as shown by the matrix shown in the above-shown Expression 8. The tag generation unit 140A generates (i.e., calculates), as a tag T[i], an exclusive OR (sum total) of the encryption result obtained by encrypting the constant fix using the TBC function E_{K}^{˜} and the encryptions result obtained by encrypting the random numbers S_i\hat{ }(1), . . . , and S_i\hat{ }(β) using the TBC function E_{K}^{˜}′. The tag generation unit 140A generates tags T[1], . . . , and T[ω] by performing the above-described processing for i=1 to ω. Then, the tag generation unit 140A outputs T[1], . . . , and T[ω] to the output unit 150 as a tag T=T[1]∥ . . . ∥T[ω].

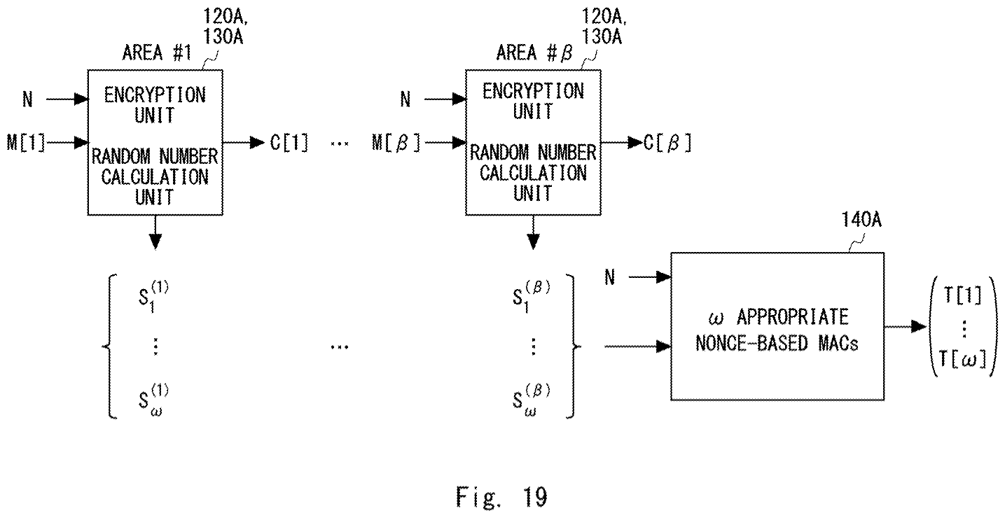

FIG. 19 is a diagram for explaining functions of the authenticated encryption apparatus 10A according to the second example embodiment. Note that in FIG. 19, the associated data is empty for the sake of clarifying the explanation. As described above, the authenticated encryption apparatus 10A groups (or divides) plaintext blocks of a plaintext M into area plaintext blocks M[1], M[2], . . . , and M[β] corresponding to an area #1, area #2, . . . , and area #β, respectively. Note that as described above, each of area plaintext blocks M[k] includes (2\hat{ }b-1) plaintext blocks.

Then, the encryption unit 120A and the random number calculation unit 130A generate, for the area #1, an area ciphertext block C[1] and a set of random numbers S_1\hat{ }(1), . . . , and S_ω\hat{ }(1) by using the input nonce N and the area plaintext block M[1]. After that, similarly, the encryption unit 120A and the random number calculation unit 130A generate, for each of the areas #k, an area ciphertext block C[k] and a set of random numbers S_1\hat{ }(k), . . . , and S_ω\hat{ }(k) by using the input nonce N and an area plaintext block M[k]. Then, the tag generation unit 140A generates tags T[1], . . . , and T[ω] by using ω appropriate nonce-based MACs as described above by using the set of generated random numbers S (matrix shown in Expression 8) and the nonce N as inputs.

In this process, the encryption unit 120A can perform processing for each area by using the calculation shown in FIGS. 17 and 18 as a subroutine. Further, the random number calculation unit 130A can perform processing, for each area, by calling the matrix AM shown in Expression 10 and using the calculation shown in FIGS. 16 to 18 as a subroutine. Note that it is necessary to initialize the initial value for each area. The same applies to the decryption processing performed by the authenticated decryption apparatus 20A (which will be described later).

### <Authenticated Decryption Apparatus>

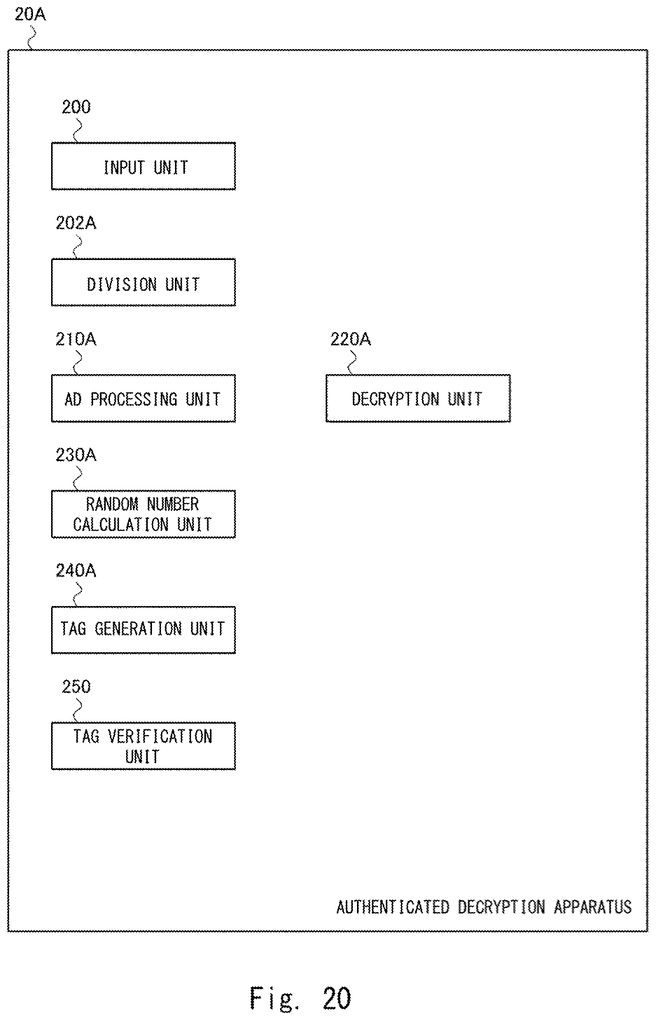

FIG. 20 shows a configuration of an authenticated decryption apparatus 20A according to the second example embodiment. As shown in FIG. 20, the authenticated decryption apparatus 20A includes an input unit 200, a division unit 202A, an AD processing unit 210A, a decryption unit 220A, a random number calculation unit 230A, a tag generation unit 240A, and a tag verification unit 250.

The authenticated decryption apparatus 20A corresponds to the authenticated decryption apparatus 20 shown in FIGS. 2 and 9. The division unit 202A corresponds to the division unit 202 according to the first example embodiment. The AD processing unit 210A corresponds to the AD processing unit 210 according to the first example embodiment. The decryption unit 220A corresponds to the decryption unit 220 according to the first example embodiment. The random number calculation unit 230A corresponds to the random number calculation unit 230 according to the first example embodiment. The tag generation unit 240A corresponds to the tag generation unit 240 according to the first example embodiment. Note that the configuration of the authenticated decryption apparatus 20A will be described with a particular emphasis on parts thereof that are different from those of the authenticated decryption apparatus 20.

Similarly to the division unit 102A, the division unit 202A divides each of a ciphertext C and associated data A into blocks each having a predetermined length. Specifically, the division unit 202A divides the ciphertext C into ciphertext blocks C_1, . . . , and C_m each having b bits. Further, the division unit 202A divides the associated data A into AD blocks A_1, . . . , and A_a each having a length of b bits. The division unit 202A outputs the AD blocks A_1, . . . , and A_a to the AD processing unit 210A.

Further, similarly to the above-described division unit 102A, the division unit 202A groups (or divides) the divided AD blocks A_1, . . . , and A_a and the divided ciphertext blocks C_1, . . . , and C_m into areas (groups) each containing (2\hat{ }b-1) blocks. That is, one area contains (2\hat{ }b-1) blocks. Note that the division unit 202A may group (i.e., divide) a data string D=A_1∥ . . . ∥A_a∥C_1∥ . . . ∥C_m into areas so that they are grouped, from the first block of the data string, in the order of an area #1, area #2, . . . , and area #β. Note that the grouping method may be the same as the above-described method for the division unit 102A.

Note that when a bit string of ciphertext blocks grouped into an area #k is expressed as an “area ciphertext block C[k]”, the ciphertext C may also be expressed as C=C[1]∥C[2]∥ . . . ∥C[β]. Note that the number of ciphertext blocks included in each of area ciphertext blocks C[k] other than at least C[1] and C[β] becomes (2\hat{ }b-1). Further, when the associated data is empty, the number of ciphertext blocks included in the area ciphertext block C[1] also becomes (2\hat{ }b-1).

The AD processing unit 210A performs substantially the same processing as that performed by the above-described AD processing unit 110A. That is, the AD processing unit 210A processes the AD blocks A_1, . . . , and A_a by using the TBC function in which a key K and a Tweak are input. Note that the AD processing unit 210A processes the AD blocks on an area-by-area basis as described above. The AD processing unit 210A outputs intermediate values Z_1, . . . , and Z_a, which are the output values (random numbers) of respective TBC functions, to the random number calculation unit 230A. Note that the Tweak input to each of the TBC functions used in the AD processing unit 210A may be set substantially the same manner as the Tweak input to each of the TBC functions used in the above-described AD processing unit 110A.

The decryption unit 220A performs decryption processing corresponding to the above-described encryption processing performed by the encryption unit 120A. The decryption unit 220A processes the ciphertext block C_1, . . . , and C_m in parallel with each other by using the TBC function in which the key K and the Tweak are input. Note that the decryption unit 220A decrypts ciphertext blocks (ciphertext) in parallel with each other on an area-by-area basis as described above. That is, the decryption unit 220A performs, for ciphertext blocks included in the area #1, decryption processing corresponding to the above-described encryption processing performed by the encryption unit 120A. Then, the decryption unit 220A performs, for ciphertext blocks included in the area #2, decryption processing corresponding to the above-described encryption processing performed by the encryption unit 120A. After that, the decryption unit 220A performs, for ciphertext blocks included in an area #k, decryption processing corresponding to the above-described encryption processing performed by the encryption unit 120A. That is, the decryption unit 220A decrypts the area ciphertext blocks C[k] included in the area #k. The decryption unit 220A obtains plaintext blocks as output values of the TBC functions by inputting ciphertext blocks into respective TBC functions (decryption functions) in which the key K and Tweaks are input. This decryption function is configured to perform decryption processing corresponding to the encryption processing performed by TBC function E_{K}^{˜} used in the above-described encryption unit 120A.

The decryption unit 220A outputs the generated plaintext blocks M_1, . . . , and M_m to the tag verification unit 250 as a plaintext M=M_1∥ . . . ∥M_m. Further, the decryption unit 220A obtains an area plaintext block M[k] by decrypting area ciphertext blocks C[k] included in the area #k. Note that the decryption unit 220A may output the obtained plaintext to the tag verification unit 250 as a plaintext M=M[1]∥M[2]∥ . . . ∥M[β]. Further, the decryption unit 220A outputs plaintext blocks (output values of the TBC functions), which will be output from the TBC functions (decryption functions) in respective areas, to the random number calculation unit 230A as intermediate values Z.

Note that the calculation performed by the decryption unit 220A corresponds to one that is obtained by, in the encryption unit 120A shown in FIGS. 17 and 18, replacing the TBC functions, which are the encryption functions, with decryption functions and inputting ciphertext blocks to the decryption functions (TBC functions) so that plaintext blocks are output. Note that the Tweak input to each of the TBC functions used in the decryption unit 220A may be set substantially the same manner as the Tweak input to each of the TBC functions used in the above-described encryption unit 120A.

Similarly to the above-described random number calculation unit 130A, the random number calculation unit 230A calculates random numbers for generating a tag by using the random numbers Z generated by the AD processing unit 210A and the decryption unit 220A and the predetermined matrix AM shown in Expression 10. Note that the random number calculation unit 230A calculates random numbers for each area. Specifically, the random number calculation unit 230A generates, for each area, a set of w random numbers S (S_1, . . . , and S_ω) by using intermediate values Z generated by the AD processing unit 210A and the decryption unit 220A and the predetermined matrix AM. Note that the set of random numbers S is used to generate a verification tag T*. Similarly to the above-described random number calculation unit 130A, the random number calculation unit 230A calculates, in each area, S_i by calculating an exclusive OR of products of intermediate value Z_j and α_(i, j) for each of ω lines i (1≤i≤w). That is, the random number calculation unit 230A generates, in each area #k, a set of random numbers S_1\hat{ }(k), . . . , and S_ω\hat{ }(k) by processing the random numbers Z_1\hat{ }(k), . . . , and Z_(2\hat{ }b-1)\hat{ }(k) by using the matrix AM as shown in the above-shown Expression 11.

Note that the random number calculation unit 230A initializes (i.e., resets), for each area, the initial value of each line of the exclusive OR of products of Z and α. That is, the random number calculation unit 230A sets, for each area, the initial value of a line i to 0\hat{ }b. In other words, the random number calculation unit 230A initializes (i.e., resets), for each area, the initial value of each of a plurality of lines in which a set of random numbers is generated. The random number calculation unit 230A outputs the set of random numbers S_1\hat{ }(k), and S_ω\hat{ }(k) generated for each area #k to the tag generation unit 240A.

Similarly to the tag generation unit 240 according to the first example embodiment, the tag generation unit 240A generates a tag. The tag generation unit 240A generates, by using the set of random numbers S generated by the random number calculation unit 230A and the nonce N, a verification tag T* by a message authentication code using a Tweakable block cipher. Note that the method for generating a tag T* is substantially the same as the method for generating a tag T in the tag generation unit 240 according to the first example embodiment. That is, the tag generation unit 240A generates (i.e., calculates), as a tag T*[i], an exclusive OR (sum total) of the encryption result obtained by encrypting the constant fix using the TBC function E_{K}^{˜} and the encryption results obtained by encrypting the random numbers S_i\hat{ }(1), . . . , and S_i\hat{ }(β) using the TBC function E_{K}^{˜}′. The tag generation unit 240A generates tags T*[1], . . . , and T*[ω] by performing the above-described processing for i=1 to w. Then, the tag generation unit 240A outputs T*[1], . . . , and T*[ω] to the tag verification unit 250 as a tag T*=T*[1]∥ . . . ∥T*[ω].

### <Effects>

The authenticated encryption system 1 according to the second example embodiment can provide substantially the same effects as those provided by the above-described authenticated encryption system 1 according to the first example embodiment. That is, as described above, the authenticated encryption apparatus 10A according to the second example embodiment groups (i.e., divides) input blocks (AD blocks and plaintext blocks) into areas containing (2\hat{ }b-1) blocks, i.e., having a size that can be processed by the method according to the comparative example. Further, the authenticated encryption apparatus 10A according to the second example embodiment is configured to appropriately derive a tag T from a set of random numbers S generated in each area. In this way, the authenticated encryption system 1 according to the second example embodiment can process (2\hat{ }b-1) input blocks or more, which cannot be handled in the technique according to the comparative example due to the security reason. Further, in the authenticated encryption system 1 according to the second example embodiment, since there is no limit on the number of blocks that can be processed, it is possible to transmit a ciphertext all at once irrespective of the size of the plaintext. That is, similarly to the first example embodiment, only one set of items (N, A, C, T) needs to be transmitted in the second example embodiment. Therefore, the communication load can be reduced.

### Third Example Embodiment

Next, a third example embodiment will be described. As the third example embodiment, an outline of the configuration of the above-described example embodiment will be shown.

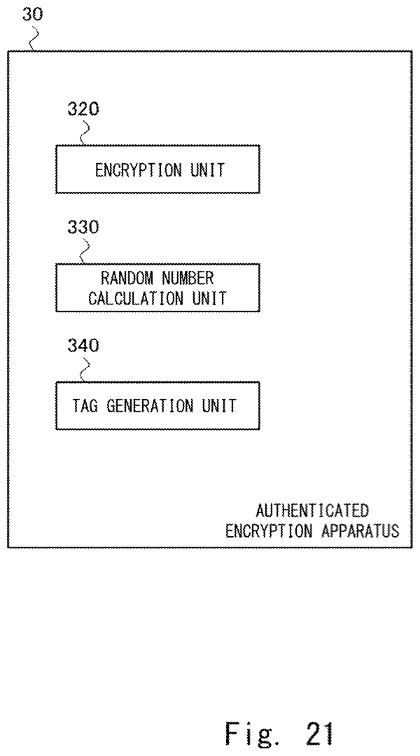

FIG. 21 shows a configuration of an authenticated encryption apparatus 30 according to the third example embodiment. The authenticated encryption apparatus 30 according to the third example embodiment corresponds to the authenticated encryption apparatus 10 according to the first example embodiment and the authenticated encryption apparatus 10A according to the second example embodiment. The authenticated encryption apparatus 30 according to the third example embodiment includes an encryption unit 320, a random number calculation unit 330, and a tag generation unit 340. The encryption unit 320 functions as encryption means. The random number calculation unit 330 functions as random number calculation means (first random number calculation means). The tag generation unit 340 functions as tag generation means (first tag generation means).

The encryption unit 320 can be implemented by functions substantially the same as those of the encryption unit 120 shown in FIG. 3 or the encryption unit 120A shown in FIG. 15. The encryption unit 320 encrypts a plaintext, which is divided into plaintext blocks each having a predetermined length (e.g., b bits), on an area-by-area basis, in which each area has a predetermined length, by using a Tweakable block cipher (TBC function) using a nonce as a Tweak.

Note that in the above-described example embodiment, when the bit length of a plaintext block is set to b bits, the “area having a predetermined length” corresponds to an area in which (2\hat{ }b-2) blocks can be contained in the first example embodiment, and corresponds to an area in which (2\hat{ }b-1) blocks can be contained in the second example embodiment. However, the “area having a predetermined length” is not limited to areas in which such a predetermined number of blocks can be contained. Note that as described above, the last area does not need to contain (2\hat{ }b-2) (or (2\hat{ }b-1)) blocks. Further, there are cases where when associated data is input, at least the first area may not contain (2\hat{ }b-2) (or (2\hat{ }b-1)) plaintext blocks. The same applies to an authenticated decryption apparatus 40 according to the third example embodiment (which will be described later).

The random number calculation unit 330 can be implemented by functions substantially the same as those of the random number calculation unit 130 shown in FIG. 3 or the random number calculation unit 130A shown in FIG. 15. In encryption, the random number calculation unit 330 generates a set of random numbers for each area by using first data derived from at least one of an input and an output of a function related to a Tweakable block cipher in each area and a predetermined matrix having predetermined values as its elements.

Note that the “function related to a Tweakable block cipher” corresponds to the TBC function in the above-described example embodiments. Further, the “first data” corresponds to the random number Z output from the TBC function in the first example embodiment. Meanwhile, the “first data” corresponds to the plaintext block (intermediate value Z) input to the TBC function in the second example embodiment. Note that the first data is not limited to the data input to the TBC function or the data output from the TBC function. The first data may be derived by using both input data and output data of the TBC function. Further, the “function related to a Tweakable block cipher” is not limited to the TBC function in the above-described example embodiments. The same applies to the authenticated decryption apparatus 40 according to the third example embodiment (which will be described later).

Further, the “predetermined matrix” corresponds to, but is not limited to, the above-described matrix AM. Note that, the “predetermined matrix” corresponds to the matrix AM shown in Expression 5 in the above-described first example embodiment. Further, the “predetermined matrix” corresponds to the matrix AM shown in Expression 10 in the above-described second example embodiment. Further, the “predetermined value” corresponds to, but is not limited to, the element α of the above-described matrix AM. Further, the random number generated by the random number calculation unit 330 corresponds to, but is not limited to, the above-described random number S. The same applies to the authenticated decryption apparatus 40 according to the third example embodiment (which will be described later).

The tag generation unit 340 can be implemented by functions substantially the same as those of the tag generation unit 140 shown in FIG. 3 or the tag generation unit 140A shown in FIG. 15. The tag generation unit 340 generates, by using a set of random numbers and a nonce, an authentication tag by a message authentication code using a Tweakable block cipher.

Note that the generated tag corresponds to the above-described tag T. Further, the “message authentication code using a Tweakable block cipher” corresponds to, but is not limited to, the nonce-based MAC in the above-described example embodiments. The same applies to the authenticated decryption apparatus 40 according to the third example embodiment (which will be described later).

Further, similarly to the above-described example embodiment, the random number calculation unit 330 may generate a set of random numbers by using the same predetermined matrix for all the areas. Further, similarly to the above-described example embodiment, when the random number calculation unit 330 generates a set of random numbers, it may initialize, for each area, the initial value of a line in which the set of random numbers is generated. Further, similarly to the above-described example embodiment, the random number calculation unit 330 may generate, for each of β areas, a set of random numbers consisting of a number of random numbers corresponding to a value ω indicating a predetermined security level. Note that the tag generation unit 340 may generate a set of ω tags based on a random number matrix having a size of ω×β and having random numbers as its elements. Note that the “number corresponding to a value ω indicating a predetermined security level” corresponds to ω-1 in the first example embodiment, and corresponds to w in the second example embodiment. Further, in this process, similarly to the above-described example embodiment, the tag generation unit 340 may process ω message authentication codes. Further, similarly to the above-described example embodiment, the tag generation unit 340 may generate a tag by an exclusive OR of a value obtained by encrypting a constant using the TBC function including a nonce as a Tweak and a value obtained by encrypting a random number generated for each area. The same applies to the authenticated decryption apparatus 40 according to the third example embodiment (which will be described later).

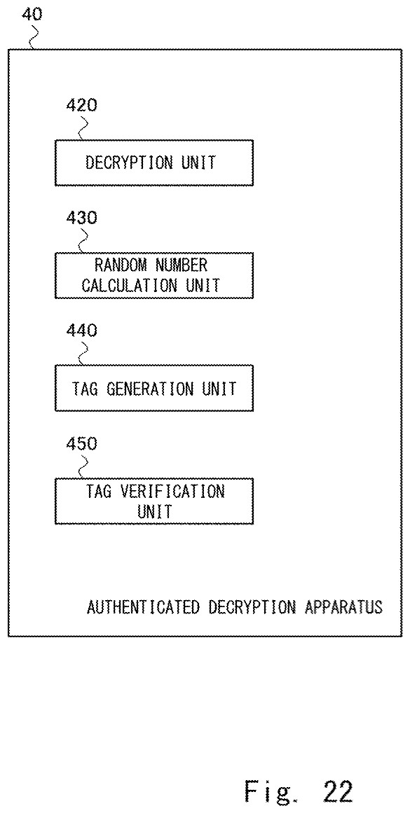

FIG. 22 shows a configuration of an authenticated decryption apparatus 40 according to the third example embodiment. The authenticated decryption apparatus 40 according to the third example embodiment corresponds to the authenticated decryption apparatus 20 according to the first example embodiment, and corresponds to the authenticated decryption apparatus 20A according to the second example embodiment. The authenticated decryption apparatus 40 according to the third example embodiment includes a decryption unit 420, a random number calculation unit 430, a tag generation unit 440, and a tag verification unit 450. The decryption unit 420 functions as decryption means. The random number calculation unit 430 functions as random number calculation means (second random number calculation means). The tag generation unit 440 functions as tag generation means (second tag generation means). The tag verification unit 450 functions as tag verification means.

The decryption unit 420 can be implemented by functions substantially the same as those of the decryption unit 220 shown in FIG. 9 or the decryption unit 220A shown in FIG. 20. By using a Tweakable block cipher (TBC function) in which a nonce is used as a Tweak, the decryption unit 420 decrypts, for each area having a predetermined length, a ciphertext divided into ciphertext blocks each having a predetermined length (e.g., b bits).

The random number calculation unit 430 may be implemented by functions substantially the same as those of the random number calculation unit 230 shown in FIG. 9 or the random number calculation unit 230A shown in FIG. 20. In decryption, the random number calculation unit 430 generates a set of random numbers for each area by using first data derived from at least one of an input and an output of a function related to a Tweakable block cipher in each area and a predetermined matrix having predetermined values as its elements.

The tag generation unit 440 can be implemented by functions substantially the same as those of the tag generation unit 240 shown in FIG. 9 or the tag generation unit 240A shown in FIG. 20. The tag generation unit 440 generates, by using a set of random numbers and a nonce, a verification tag by a message authentication code using a Tweakable block cipher.

The tag verification unit 450 can be implemented by functions substantially the same as those of the tag verification unit 250 shown in FIG. 9 or 20. By comparing a verification tag with an input authentication tag, the tag verification unit 450 performs control so as to verify (i.e., check) whether or not tampering has occurred and output a verification result.

By the above-described configuration, the authenticated encryption apparatus 30 and the authenticated decryption apparatus 40 according to the third example embodiment can increase the number of plaintext blocks that can be processed in one authenticated encryption process and to achieve high security at the same time. Note that an authenticated encryption system including the authenticated encryption apparatus 30 and the authenticated decryption apparatus 40 can also increase the number of plaintext blocks that can be processed in one authenticated encryption process and to achieve high security at the same time. Further, an authenticated encryption method performed by the authenticated encryption apparatus 30 and a program for performing an authenticated encryption method can also increase the number of plaintext blocks that can be processed in one authenticated encryption process and to achieve high security at the same time. It is possible to reduce delays in encryption and decryption. Further, ab authenticated decryption method performed by the authenticated decryption apparatus 40 and a program for performing an authenticated decryption method can also increase the number of plaintext blocks that can be processed in one authenticated encryption process and to achieve high security at the same time.

### (Example of Hardware Configuration)

An example of a configuration of hardware resources for implementing an apparatus and a system according to the above-described example embodiment by using one calculation processing apparatus (an information processing apparatus or a computer) will be described. However, the apparatus according to any of the example embodiments (authenticated encryption apparatus and authenticated decryption apparatus) may be physically or functionally implemented by using at least two calculation processing apparatus. Further, the apparatus according to any of the example embodiments may be implemented as a dedicated apparatus or as a general-purpose information processing apparatus.

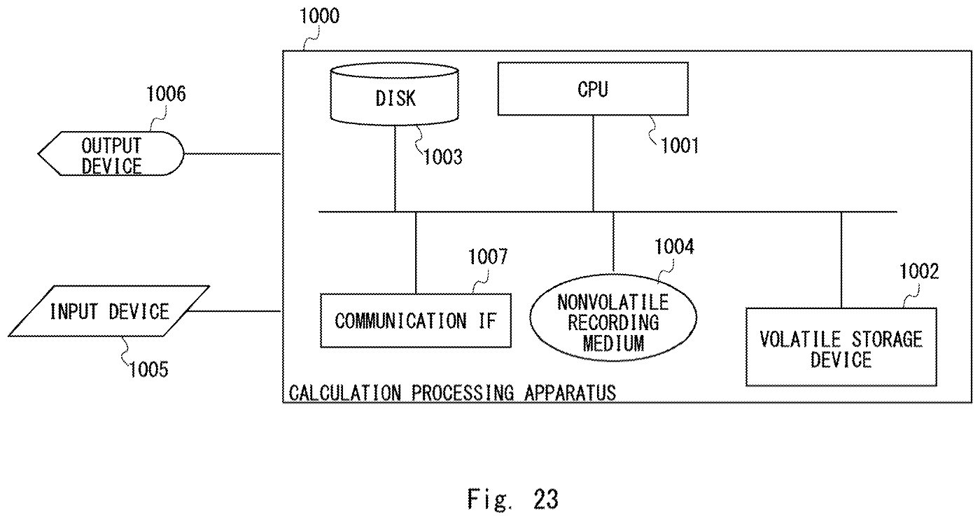

FIG. 23 is a block diagram schematically showing an example of a hardware configuration of a calculation processing apparatus capable of implementing an apparatus and a system according to any of the example embodiments. A calculation processing apparatus 1000 includes a CPU 1001, a volatile storage device 1002, a disk 1003, a nonvolatile recording medium 1004, and a communication IF (IF: Interface) 1007. Therefore, it can be said that the apparatus according to any of the example embodiments includes the CPU 1001, the volatile storage device 1002, the disk 1003, the nonvolatile recording medium 1004, and the communication IF 1007. The calculation processing apparatus 1000 may be configured so that it can be connected to an input device 1005 and an output device 1006. The calculation processing apparatus 1000 may include the input device 1005 and the output device 1006. Further, the calculation processing apparatus 1000 may transmit/receive information to/from other calculation processing apparatuses and communication apparatuses through the communication IF 1007.

The nonvolatile recording medium 1004 is, for example, a computer readable CD (Compact Disc) or a computer readable DVD (Digital Versatile Disc). Further, the nonvolatile recording medium 1004 may be a USB (Universal Serial Bus) memory, an SSD (Solid State Drive), or the like. The nonvolatile recording medium 1004 holds (i.e., retains) a relevant program(s) even when no electric power is supplied, thus enabling the program(s) to be carried and transported. Note that the nonvolatile recording medium 1004 is not limited to the above-described media. Alternatively, instead of using the nonvolatile recording medium 1004, the relevant program(s) may be supplied through the communication IF 1007 and a communication network(s).

The volatile storage device 1002 can be read by a computer, and can temporarily store data. The volatile storage device 1002 is a memory or the like such as a DRAM (dynamic random access memory) or an SRAM (static random access memory).

That is, the CPU 1001 copies (i.e., loads) a software program (a computer program: hereinafter also simply referred to as a “program”) stored in the disc 1003 into the volatile storage device 1002 when it executes the program, and thereby performs arithmetic processing. The CPU 1001 reads data necessary for executing the program from the volatile storage device 1002. When it is necessary to display an output result, the CPU 1001 displays the output result on the output device 1006. When a program is input from the outside, the CPU 1001 acquires the program through the input device 1005. The CPU 1001 interprets and executes programs corresponding to the above-described functions (the processes) of the respective components shown in FIGS. 3, 9, 15 and 20-22. The CPU 1001 performs the processes described in each of the above-described example embodiments. In other words, the above-described functions of the respective components shown in FIGS. 3, 9, 15 and 20-22 can be implemented by having the CPU 1001 execute a program(s) stored in the disc 1003 or the volatile storage device 1002.

That is, it can be considered that each example embodiment can be accomplished by the above-described program. Further, it can be considered that each of the above-described example embodiments can also be accomplished by a nonvolatile recording medium which can be read by a computer and in which the above-described program is recorded.

### Modified Example

Note that the present invention is not limited to the above-described example embodiments, and they may be modified as appropriate without departing from the scope and spirit of the invention. For example, in the above-described flowcharts, the order of processes (steps) can be changed as appropriate. Further, at least one of a plurality of processes (steps) may be omitted (or skipped).

For example, in the flowchart shown in FIG. 13, the process in the step S108 may be performed before the process in the step S104 or S106. Further, the process in the step S108 may be performed in parallel with the process in the step S104 or S106. The same applies to the flowchart shown in FIG. 14.

Further, although the division of associated data A and a plaintext M is performed by the division unit 102 in the above-described first example embodiment, the present invention is not limited to such a configuration. The division of associated data A may be performed by the AD processing unit 110. Similarly, the division of a plaintext M may be performed by the encryption unit 120. Further, the grouping of AD blocks into respective areas may also be performed by the AD processing unit 110. Similarly, the grouping of plaintext blocks into respective area may be performed by the encryption unit 120. In such cases, the division unit 102 may not be indispensable. The same applies to the division units shown in FIGS. 9, 15 and 20.

Further, although the blocks (AD blocks, plaintext blocks, or ciphertext blocks) are grouped into respective areas in advance in the above-described example embodiments, the present invention is not limited to such a configuration. A number of blocks included in each area (which is (2\hat{ }b-1) in the first example embodiment and (2\hat{ }b-1) in the second example embodiment) may be grouped from the first block, and then encryption (or decryption) and random number generation processing may be performed. In such a case, when the processing of the first area is completed, the blocks in the second area are grouped, and encryption (or decryption) and random number generation processing may be performed. The same applies to the subsequent areas.

Further, although the tag generation unit generates a tag after the random numbers S for all the areas are generated in the above-described example embodiments, the present invention is not limited to such a configuration. The tag generation unit may advance the tag generation process each time a random number S is generated in one of the areas. That is, the tag generation unit may advance the tag generation process each time a random number S is generated in one of the areas and a random number is generated one by one from the first column of the random number matrix before obtaining all the elements (random numbers S) of the random number matrix shown in Expression 8. In such a case, the tag generation process may be performed in parallel with the plaintext encryption process (or ciphertext decryption process).

Specifically, in FIG. 7, the tag generation unit first generates a random number derived from a nonce and uses it as a temporary tag. Then, when a random number S_i\hat{ }(1) is generated for the first area, the tag generation unit encrypts the random number S_i\hat{ }(1) by the TBC function, calculates an exclusive OR with the temporary tag, and updates the temporary tag. The tag generation unit generates a tag T by repeating this process each time a random number S is generated for one of the areas. By performing the above-described process, it eliminates the need for storing all the elements of the random number matrix in a memory. Therefore, the storage capacity can be saved.

In the above-described examples, the program includes a set of instructions (or software codes) that, when being loaded into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disk (DVD), a Blu-ray (registered trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

Although the present invention is described above with reference to example embodiments, the present invention is not limited to the above-described example embodiments. Various modifications that can be understood by those skilled in the art can be made to the configuration and details of the present invention within the scope and spirit of the invention.

The whole or part of the example embodiments disclosed above can be described as, but not limited to, the following supplementary notes.

### (Supplementary Note 1)

An authenticated encryption apparatus comprising:
encryption means for encrypting a plaintext on an area-by-area basis by using a Tweakable block cipher using a nonce as a Tweak, the plaintext being divided into plaintext blocks each having a predetermined length, and each area having a predetermined length;
random number calculation means for generating a set of random numbers for each area by using first data and a predetermined matrix having predetermined values as its elements, the first data being derived, in the encryption, from at least one of an input and an output of a function related to the Tweakable block cipher in each area; and
tag generation means for generating, by using the set of random numbers and the nonce, an authentication tag by a message authentication code using the Tweakable block cipher.

### (Supplementary Note 2)

The authenticated encryption apparatus described in Supplementary note 1, wherein the random number calculation means generates the set of random numbers by using the same predetermined matrix for all areas.

### (Supplementary Note 3)

The authenticated encryption apparatus described in Supplementary note 1 or 2, wherein when the random number calculation means generates the set of random numbers, the random number calculation means initialize, for each area, an initial value of a line in which the set of random numbers is generated.

### (Supplementary Note 4)

The authenticated encryption apparatus described in any one of Supplementary notes 1 to 3, wherein
the random number calculation means generates, for each of β areas, the set of random numbers consisting of a number of random numbers corresponding to a value w indicating a predetermined security level, and
the tag generation means generates a set of ω tags based on a random number matrix having a size of ω×β and having the random numbers as its elements.

### (Supplementary Note 5)

The authenticated encryption apparatus described in Supplementary note 4, wherein the tag generation means processes ω message authentication codes.

### (Supplementary Note 6)

The authenticated encryption apparatus described in any one of Supplementary notes 1 to 5, wherein the tag generation means generates the tag by calculating an exclusive OR of a value obtained by encrypting a constant using the Tweakable block cipher including the nonce as the Tweak and a value obtained by encrypting the random number generated for the respective area.

### (Supplementary Note 7)

The authenticated encryption apparatus described in any one of Supplementary notes 1 to 6, wherein the tag generation means advances the tag generation process each time a random number is generated in each area.

### (Supplementary Note 8)

The authenticated encryption apparatus described in any one of Supplementary notes 1 to 7, wherein
the encryption means generates, for each area, a ciphertext block by calculating an exclusive OR of the plaintext block and an encryption result obtained by encrypting a plaintext block preceding this plaintext block by using a function related to the Tweakable block cipher, and
the random number calculation means generates the random number by calculating an exclusive OR of products of encryption results corresponding to the first data and elements of the predetermined matrix.

### (Supplementary Note 9)

The authenticated encryption apparatus described in any one of Supplementary notes 1 to 7, wherein
the encryption means generates, for each area, a ciphertext block by encrypting a plurality of plaintext blocks in parallel with each other by using a function related to the Tweakable block cipher, and
the random number calculation means generates the random number by calculating an exclusive OR of products of the plaintext block corresponding to the first data and an element of the predetermined matrix.

### (Supplementary Note 10)

An authenticated decryption apparatus comprising:
decryption means for decrypting a ciphertext on an area-by-area basis by using a Tweakable block cipher using a nonce as a Tweak, the ciphertext being divided into ciphertext blocks each having a predetermined length, and each area having a predetermined length;
random number calculation means for generating a set of random numbers for each area by using first data and a predetermined matrix having predetermined values as its elements, the first data being derived, in the decryption, from at least one of an input and an output of a function related to the Tweakable block cipher in each area;
tag generation means for generating, by using the set of random numbers and the nonce, a verification tag by a message authentication code using the Tweakable block cipher; and
tag verification means for verifying whether tempering has occurred or not by comparing the verification tag with an input authentication tag, and performing control for outputting a verification result.

### (Supplementary Note 11)

The authenticated decryption apparatus described in Supplementary note 10, wherein the random number calculation means generates the set of random numbers by using the same predetermined matrix for all areas.

### (Supplementary Note 12)

The authenticated decryption apparatus described in Supplementary note 10 or 11, wherein when the random number calculation means generates the set of random numbers, the random number calculation means initialize, for each area, an initial value of a line in which the set of random numbers is generated.

### (Supplementary Note 13)

The authenticated decryption apparatus described in any one of Supplementary notes 10 to 12, wherein
the random number calculation means generates, for each of β areas, the set of random numbers consisting of a number of random numbers corresponding to a value ω indicating a predetermined security level, and
the tag generation means generates a set of ω tags based on a random number matrix having a size of ω×β and having the random numbers as its elements.

### (Supplementary Note 14)

The authenticated decryption apparatus described in Supplementary note 13, wherein the tag generation means processes ω message authentication codes.

### (Supplementary Note 15)

The authenticated decryption apparatus described in any one of Supplementary notes 10 to 14, wherein the tag generation means generates the tag by calculating an exclusive OR of a value obtained by encrypting a constant using the Tweakable block cipher including the nonce as the Tweak and a value obtained by encrypting the random number generated for the respective area.

### (Supplementary Note 16)

The authenticated decryption apparatus described in any one of Supplementary notes 10 to 15, wherein the tag generation means advances the tag generation process each time a random number is generated in each area.

### (Supplementary Note 17)

The authenticated decryption apparatus described in any one of Supplementary notes 10 to 16, wherein
the decryption means generates, for each area, a plaintext block by calculating an exclusive OR of the ciphertext block and an encryption result obtained by encrypting a plaintext block obtained by using a ciphertext block preceding this ciphertext block by using a function related to the Tweakable block cipher, and
the random number calculation means generates the random number by calculating an exclusive OR of products of encryption results corresponding to the first data and elements of the predetermined matrix.

### (Supplementary Note 18)

The authenticated decryption apparatus described in any one of Supplementary notes 10 to 16, wherein
the decryption means generates, for each area, a plaintext block by decrypting a plurality of ciphertext blocks in parallel with each other by using a function related to the Tweakable block cipher, and
the random number calculation means generates the random number by calculating an exclusive OR of products of the plaintext block corresponding to the first data and an element of the predetermined matrix.

### (Supplementary Note 19)

An authenticated encryption system comprising:
an authenticated encryption apparatus; and
an authenticated decryption apparatus configured to communicate with the authenticated encryption apparatus, wherein
the authenticated encryption apparatus comprises:
encryption means for encrypting a plaintext on an area-by-area basis by using a Tweakable block cipher using a nonce as a Tweak, the plaintext being divided into plaintext blocks each having a predetermined length, and each area having a predetermined length;
first random number calculation means for generating a set of random numbers for each area by using data and a predetermined matrix having predetermined values as elements, the data being derived, in the encryption, from at least one of an input and an output of a function related to the Tweakable block cipher in each area; and
first tag generation means for generating, by using the set of random numbers and the nonce, an authentication tag by a message authentication code using the Tweakable block cipher, and
the authenticated decryption apparatus comprises:
decryption means for decrypting a ciphertext on an area-by-area basis by using the Tweakable block cipher using the nonce as the Tweak, the ciphertext being divided into ciphertext blocks each having a predetermined length, and each area having a predetermined length;
second random number calculation means for generating a set of random numbers for each area by using data and a predetermined matrix having predetermined values as its elements, the data being derived, in the decryption, from at least one of an input and an output of a function related to the Tweakable block cipher in each area;
second tag generation means for generating, by using the set of random numbers and the nonce, a verification tag by a message authentication code using the Tweakable block cipher; and
tag verification means for verifying whether tempering has occurred or not by comparing the verification tag with the input authentication tag, and performing control for outputting a verification result.

### (Supplementary Note 20)

An authenticated encryption method comprising:
encrypting a plaintext on an area-by-area basis by using a Tweakable block cipher using a nonce as a Tweak, the plaintext being divided into plaintext blocks each having a predetermined length, and each area having a predetermined length;
generating a set of random numbers for each area by using first data and a predetermined matrix having predetermined values as its elements, the first data being derived, in the encryption, from at least one of an input and an output of a function related to the Tweakable block cipher in each area; and
generating, by using the set of random numbers and the nonce, an authentication tag by a message authentication code using the Tweakable block cipher.

### (Supplementary Note 21)

An authenticated decryption method comprising:
decrypting a ciphertext on an area-by-area basis by using a Tweakable block cipher using a nonce as a Tweak, the ciphertext being divided into ciphertext blocks each having a predetermined length, and each area having a predetermined length;
generating a set of random numbers for each area by using first data and a predetermined matrix having predetermined values as its elements, the first data being derived, in the decryption, from at least one of an input and an output of a function related to the Tweakable block cipher in each area;
generating, by using the set of random numbers and the nonce, a verification tag by a message authentication code using the Tweakable block cipher; and
verifying whether tempering has occurred or not by comparing the verification tag with an input authentication tag, and performing control for outputting a verification result.

### (Supplementary Note 22)

A non-transitory computer readable medium storing a program for causing a computer to perform:
a step of encrypting a plaintext on an area-by-area basis by using a Tweakable block cipher using a nonce as a Tweak, the plaintext being divided into plaintext blocks each having a predetermined length, and each area having a predetermined length;
a step of generating a set of random numbers for each area by using first data and a predetermined matrix having predetermined values as its elements, the first data being derived, in the encryption, from at least one of an input and an output of a function related to the Tweakable block cipher in each area; and
a step of generating, by using the set of random numbers and the nonce, an authentication tag by a message authentication code using the Tweakable block cipher.

### (Supplementary Note 23)

A non-transitory computer readable medium storing a program for causing a computer to perform:
a step of decrypting a ciphertext on an area-by-area basis by using a Tweakable block cipher using a nonce as a Tweak, the ciphertext being divided into ciphertext blocks each having a predetermined length, and each area having a predetermined length;
a step of generating a set of random numbers for each area by using first data and a predetermined matrix having predetermined values as its elements, the first data being derived, in the decryption, from at least one of an input and an output of a function related to the Tweakable block cipher in each area;
a step of generating, by using the set of random numbers and the nonce, a verification tag by a message authentication code using the Tweakable block cipher; and
a step of verifying whether tempering has occurred or not by comparing the verification tag with an input authentication tag, and performing control for outputting a verification result.

### REFERENCE SIGNS LIST

1 AUTHENTICATED ENCRYPTION SYSTEM
10 AUTHENTICATED ENCRYPTION APPARATUS
20 AUTHENTICATED DECRYPTION APPARATUS
30 AUTHENTICATED ENCRYPTION APPARATUS
40 AUTHENTICATED DECRYPTION APPARATUS
100 INPUT UNIT
102 DIVISION UNIT
104 NONCE GENERATION UNIT
110 AD PROCESSING UNIT
120 ENCRYPTION UNIT
130 RANDOM NUMBER CALCULATION UNIT
140 TAG GENERATION UNIT
150 OUTPUT UNIT
200 INPUT UNIT
202 DIVISION UNIT
210 AD PROCESSING UNIT
220 DECRYPTION UNIT
230 RANDOM NUMBER CALCULATION UNIT
240 TAG GENERATION UNIT
250 TAG VERIFICATION UNIT
320 ENCRYPTION UNIT
330 RANDOM NUMBER CALCULATION UNIT
340 TAG GENERATION UNIT
420 DECRYPTION UNIT
430 RANDOM NUMBER CALCULATION UNIT
440 TAG GENERATION UNIT
450 TAG VERIFICATION UNIT

What is claimed is:

1. An authenticated encryption apparatus comprising:
hardware, including a processor and memory;
encryption unit implemented at least by the hardware and configured to encrypt a plaintext on an area-by-area basis by using a Tweakable block cipher using a nonce as a Tweak, the plaintext being divided into plaintext blocks each having a predetermined length, and each area having a predetermined length;
random number calculation unit implemented at least by the hardware and configured to generate a set of random numbers for each area by using first data and a predetermined matrix having predetermined values as its elements, the first data being derived, in the encryption, from at least one of an input and an output of a function related to the Tweakable block cipher in each area; and
tag generation unit implemented at least by the hardware and configured to generate, by using the set of random numbers and the nonce, an authentication tag by a message authentication code using the Tweakable block cipher.

2. The authenticated encryption apparatus according to claim 1, wherein the random number calculation unit generates the set of random numbers by using the same predetermined matrix for all areas.

3. The authenticated encryption apparatus according to claim 1, wherein when the random number calculation unit generates the set of random numbers, the random number calculation unit initialize, for each area, an initial value of a line in which the set of random numbers is generated.

4. The authenticated encryption apparatus according to claim 1, wherein
the random number calculation unit generates, for each of B areas, the set of random numbers consisting of a number of random numbers corresponding to a value ω indicating a predetermined security level, and
the tag generation unit generates a set of ω tags based on a random number matrix having a size of ω×β and having the random numbers as its elements.

5. The authenticated encryption apparatus according to claim 4, wherein the tag generation unit processes ω message authentication codes.

6. The authenticated encryption apparatus according to claim 1, wherein the tag generation unit generates the tag by calculating an exclusive OR of a value obtained by encrypting a constant using the Tweakable block cipher including the nonce as the Tweak and a value obtained by encrypting the random number generated for the respective area.

7. The authenticated encryption apparatus according to claim 1, wherein the tag generation unit advances the tag generation process each time a random number is generated in each area.

8. The authenticated encryption apparatus according to claim 1, wherein
the encryption unit generates, for each area, a ciphertext block by calculating an exclusive OR of the plaintext block and an encryption result obtained by encrypting a plaintext block preceding this plaintext block by using a function related to the Tweakable block cipher, and
the random number calculation unit generates the random number by calculating an exclusive OR of products of encryption results corresponding to the first data and elements of the predetermined matrix.

9. The authenticated encryption apparatus according to claim 1, wherein
the encryption unit generates, for each area, a ciphertext block by encrypting a plurality of plaintext blocks in parallel with each other by using a function related to the Tweakable block cipher, and
the random number calculation unit generates the random number by calculating an exclusive OR of products of the plaintext block corresponding to the first data and an element of the predetermined matrix.

10. An authenticated decryption apparatus comprising:
hardware, including a processor and memory;
decryption unit implemented at least by the hardware and configured to decrypt a ciphertext on an area-by-area basis by using a Tweakable block cipher using a nonce as a Tweak, the ciphertext being divided into ciphertext blocks each having a predetermined length, and each area having a predetermined length;
random number calculation unit implemented at least by the hardware and configured to generate a set of random numbers for each area by using first data and a predetermined matrix having predetermined values as its elements, the first data being derived, in the decryption, from at least one of an input and an output of a function related to the Tweakable block cipher in each area;
tag generation unit implemented at least by the hardware and configured to generate, by using the set of random numbers and the nonce, a verification tag by a message authentication code using the Tweakable block cipher; and
tag verification unit implemented at least by the hardware and configured to verify whether tempering has occurred or not by comparing the verification tag with an input authentication tag, and performing control for outputting a verification result.

11. The authenticated decryption apparatus according to claim 10, wherein the random number calculation unit generates the set of random numbers by using the same predetermined matrix for all areas.

12. The authenticated decryption apparatus according to claim 10, wherein when the random number calculation unit generates the set of random numbers, the random number calculation unit initialize, for each area, an initial value of a line in which the set of random numbers is generated.

13. The authenticated decryption apparatus according to claim 10, wherein
the random number calculation unit generates, for each of β areas, the set of random numbers consisting of a number of random numbers corresponding to a value ω indicating a predetermined security level, and
the tag generation unit generates a set of w tags based on a random number matrix having a size of ω×β and having the random numbers as its elements.

14. The authenticated decryption apparatus according to claim 13, wherein the tag generation unit processes w message authentication codes.

15. The authenticated decryption apparatus according to claim 10, wherein the tag generation unit generates the tag by calculating an exclusive OR of a value obtained by encrypting a constant using the Tweakable block cipher including the nonce as the Tweak and a value obtained by encrypting the random number generated for the respective area.

16. The authenticated decryption apparatus according to claim 10, wherein the tag generation unit advances the tag generation process each time a random number is generated in each area.

17. The authenticated decryption apparatus according to claim 10, wherein
the decryption unit generates, for each area, a plaintext block by calculating an exclusive OR of the ciphertext block and an encryption result obtained by encrypting a plaintext block obtained by using a ciphertext block preceding this ciphertext block by using a function related to the Tweakable block cipher, and
the random number calculation unit generates the random number by calculating an exclusive OR of products of encryption results corresponding to the first data and elements of the predetermined matrix.

18. The authenticated decryption apparatus according to claim 10, wherein
the decryption unit generates, for each area, a plaintext block by decrypting a plurality of ciphertext blocks in parallel with each other by using a function related to the Tweakable block cipher, and
the random number calculation unit generates the random number by calculating an exclusive OR of products of the plaintext block corresponding to the first data and an element of the predetermined matrix.

19. (canceled)

20. An authenticated encryption method comprising:
encrypting a plaintext on an area-by-area basis by using a Tweakable block cipher using a nonce as a Tweak, the plaintext being divided into plaintext blocks each having a predetermined length, and each area having a predetermined length;
generating a set of random numbers for each area by using first data and a predetermined matrix having predetermined values as its elements, the first data being derived, in the encryption, from at least one of an input and an output of a function related to the Tweakable block cipher in each area; and
generating, by using the set of random numbers and the nonce, an authentication tag by a message authentication code using the Tweakable block cipher.

21. An authenticated decryption method comprising:
decrypting a ciphertext on an area-by-area basis by using a Tweakable block cipher using a nonce as a Tweak, the ciphertext being divided into ciphertext blocks each having a predetermined length, and each area having a predetermined length;
generating a set of random numbers for each area by using first data and a predetermined matrix having predetermined values as its elements, the first data being derived, in the decryption, from at least one of an input and an output of a function related to the Tweakable block cipher in each area;
generating, by using the set of random numbers and the nonce, a verification tag by a message authentication code using the Tweakable block cipher; and
verifying whether tempering has occurred or not by comparing the verification tag with an input authentication tag, and performing control for outputting a verification result.

22. A non-transitory computer readable medium storing a program for causing a computer to perform:
a step of encrypting a plaintext on an area-by-area basis by using a Tweakable block cipher using a nonce as a Tweak, the plaintext being divided into plaintext blocks each having a predetermined length, and each area having a predetermined length;
a step of generating a set of random numbers for each area by using first data and a predetermined matrix having predetermined values as its elements, the first data being derived, in the encryption, from at least one of an input and an output of a function related to the Tweakable block cipher in each area; and
a step of generating, by using the set of random numbers and the nonce, an authentication tag by a message authentication code using the Tweakable block cipher.

23. (canceled)
